(19) United States
(12) Patent Application Publication
(10) Pub. No.: US 2024/0348575 A1
(43) Pub. Date: Oct. 17, 2024

(54) IDENTIFICATION OF AN EDGE ENABLER CLIENT (EEC) IN AN EDGE APPLICATION SERVER (EAS) AND AN EDGE ENABLER SERVER (EES) IN AN EDGE DATA NETWORK

(71) Applicant: QUALCOMM Incorporated, San Diego, CA (US)

(72) Inventors: Sunghoon KIM, San Diego, CA (US); Dario Serafino TONESI, San Diego, CA (US); Haris ZISIMOPOULOS, London (GB); Tom CHIN, San Diego, CA (US); Ajith Tom PAYYAPPILLY, San Diego, CA (US); Juan ZHANG, San Diego, CA (US); Alan SOLOWAY, Frederick, CO (US); Waqar ZIA, Munich (DE)

(21) Appl. No.: 18/576,613

(22) PCT Filed: Aug. 11, 2022
(86) PCT No.: PCT/US22/40134

§ 371 Date: Jan. 4, 2024

(30) Foreign Application Priority Data
Aug. 13, 2021 (GR) 20210100550

(51) Int. Cl. H04L 61/2503

(52) U.S. Cl. CPC H04L 61/2503

(57) ABSTRACT

An apparatus for wireless communication is provided. The apparatus may be a user equipment (UE). The apparatus receives a token from a first server in an edge data network. For example, the first server may be an edge application server (EAS). The apparatus transmits identification information associated with the apparatus to a second server of the edge data network. For example, the second server may be an edge enabler server (EES). The identification information includes at least the token, an identifier of the apparatus, and an identifier of the first server, wherein the identifier of the apparatus is independent of an Internet Protocol (IP) address of the apparatus.

### CROSS-REFERENCE TO RELATED APPLICATION

This application claims priority to and the benefit of Greek patent application Ser. No. 20/210,100550, entitled “IDENTIFICATION OF AN EDGE ENABLER CLIENT (EEC) IN AN EDGE APPLICATION SERVER (EAS) AND AN EDGE ENABLER SERVER (EES) IN AN EDGE DATA NETWORK,” filed with the Greek Patent and Trademark Office on Aug. 13, 2021, the entire contents of which are incorporated herein by reference as if fully set forth below in their entireties and for all applicable purposes.

### BACKGROUND

### Technical Field

The present disclosure relates generally to communication systems, and more particularly, to identification of an edge enabler client (EEC) in an edge application server (EAS) and an edge enabler server (EES) in an edge data network.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives a token from a first server in an edge data network, and transmits identification information associated with the apparatus to a second server of the edge data network, wherein the identification information includes at least the token, an identifier of the apparatus, and an identifier of the first server, wherein the identifier of the apparatus is independent of an Internet Protocol (IP) address of the apparatus.

In an aspect of the disclosure, a method, a computer-readable medium, and an apparatus are provided. The apparatus receives, from a user equipment (UE), identification information associated with the UE, wherein the identification information includes at least, an identifier of the UE, an identifier of an application server in an edge data network, and a token associated with the application server, wherein the identifier of the UE is independent of an Internet Protocol (IP) address of the UE. The apparatus receives, from the application server, a service request including at least the token and the identifier of the application server, wherein the apparatus includes a mapping between an edge enabler client identifier (EEC ID), the token, the identifier of the application server, and the identifier of the UE. The apparatus transmits, to the application server, a message in response to the service request based on at least the mapping.

In an aspect of the disclosure, a method, a computer-readable medium, and an apparatus are provided. The apparatus receives a network address of a first server configured to provide public network address information associated with a user equipment (UE); transmits, to the first server based on the network address, a request for the public network address information associated with the UE; receives the public network address information associated with the UE from the first server in response to the request; and transmits to a second server in an edge data network, the public network address information associated with the UE and private network address information associated with the UE when network address translation is applied to the private network address information associated with the UE.

In an aspect of the disclosure, a method, a computer-readable medium, and an apparatus are provided. The apparatus receives, from a user equipment (UE), at least public network address information associated with the UE; receives, from an application server in an edge data network, a service request including at least the public network address information associated with the UE, wherein the apparatus includes a mapping between private network address information associated with the UE and the public network address information associated with the UE; and transmits, to the application server in the edge data network, a message in response to the service request based on at least the mapping.

In an aspect of the disclosure, a method, a computer-readable medium, and an apparatus are provided. The apparatus receives, from a user equipment (UE), a message including at least one user plane data packet; determines public network address information of the UE based on the message; receives, from a network address translation (NAT) device, private network address information associated with the UE; receives, from an application server in an edge data network, a service request including at least the public network address information associated with the UE, wherein the apparatus includes a mapping between the private network address information associated with the UE and the public network address information associated with the UE; and transmits, to the application server in the edge data network, a message in response to the service request based on at least the mapping.

In an aspect of the disclosure, a method for wireless communication includes: receiving a token from a first server in an edge data network; and transmitting identification information associated with a user equipment (UE) to a second server of the edge data network, wherein the identification information includes at least the token, an identifier of the UE, and an identifier of the first server, wherein the identifier of the UE is independent of an Internet Protocol (IP) address of the UE. In an aspect of the disclosure, the identifier of the UE is a generic public subscription identifier (GPSI). In an aspect of the disclosure, the first server is an edge application server (EAS) and the second server is an edge enabler server (EES). In an aspect of the disclosure, the identification information is associated with an identifier of an edge enabler client (EEC) in the UE.

In an aspect of the disclosure, a method for wireless communication includes: receiving, from a user equipment (UE), identification information associated with the UE, wherein the identification information includes at least, an identifier of the UE, an identifier of an application server in an edge data network, and a token associated with the application server, wherein the identifier of the UE is independent of an Internet Protocol (IP) address of the UE; receiving, from the application server, a service request including at least the token and the identifier of the application server, wherein the apparatus includes a mapping between an edge enabler client identifier (EEC ID), the token, the identifier of the application server, and the identifier of the UE; and transmitting, to the application server, a message in response to the service request. In an aspect of the disclosure, the method further includes: determining at least one of the EEC ID or the identifier of the UE in response to the service request based on the token, the identifier of the application server, and the mapping between the EEC ID, the token, the identifier of the application server, and the identifier of the UE; and executing the service request based on at least one of the EEC ID or the identifier of the UE. In an aspect of the disclosure, the method further includes: generating a table including the mapping between the token, the identifier of the application server, and the identifier of the UE. In an aspect of the disclosure, the identifier of the UE is a generic public subscription identifier (GPSI) or the token. In an aspect of the disclosure, the method further includes: assigning a second identifier to the UE; and transmitting the second identifier of the UE to the application server; wherein the mapping between the edge enabler client identifier (EEC ID), the token, the identifier of the application server, and the identifier of the UE maps the second UE identifier to the edge enabler client identifier (EEC ID), the token, the identifier of the application server, and the identifier of the UE.

In an aspect of the disclosure, a method for wireless communication includes: receiving a network address of a first server configured to provide public network address information associated with a user equipment (UE); transmitting, to the first server based on the network address, a request for the public network address information associated with the UE; receiving the public network address information associated with the UE from the first server in response to the request; and transmitting, to a second server in an edge data network, the public network address information associated with the UE and private network address information associated with the UE when network address translation is applied to the private network address information associated with the UE. In an aspect of the disclosure, the receiving the network address of the first server configured to provide public network address information associated with the UE comprises: receiving the network address of the first server from at least one of: an entity in a core network via a parameter in a protocol configuration options (PCO) information element (IE), an edge configuration server (ECS) in an edge data network, or an edge enabler server (EES) in the edge data network. In an aspect of the disclosure, the first server is a Session Traversal Utilities for NAT (STUN) server and the second server is an edge enabler server (EES). In an aspect of the disclosure, the method further includes: transmitting an identifier of the UE to the second server. In an aspect of the disclosure, the identifier of the UE is a generic public subscription identifier (GPSI). In an aspect of the disclosure, the method further includes: determining whether network address translation is applied to the private network address information associated with the UE.

In an aspect of the disclosure, a method for wireless communication for an apparatus includes: receiving, from a user equipment (UE), at least public network address information associated with the UE; receiving, from an application server in an edge data network, a service request including at least the public network address information associated with the UE, wherein the apparatus includes a mapping between private network address information associated with the UE and the public network address information associated with the UE; and transmitting, to the application server in the edge data network, a message in response to the service request. In an aspect of the disclosure, the method further includes: determining the private network address information associated with the UE in response to the service request based on the public network address information associated with the UE and the mapping between the private network address information associated with the UE and the public network address information associated with the UE; and executing the service request based on the private network address information associated with the UE. In an aspect of the disclosure, the method further includes: invoking a network exposure function (NEF) application programming interface (API) based on the private network address information associated with the UE.

In an aspect of the disclosure, the method further includes: transmitting, to the UE, a network address of a server configured to provide the public network address information associated with the UE. In an aspect of the disclosure, the method further includes: receiving, from the UE, an identifier of the UE, wherein the mapping between the private network address information associated with the UE and the public network address information associated with the UE maps the identifier of the UE to the private network address information associated with the UE and the public network address information associated with the UE. In an aspect of the disclosure, the identifier of the UE is a generic public subscription identifier (GPSI). In an aspect of the disclosure, the public network address information associated with the UE includes a first Internet Protocol (IP) address and a first port number, and wherein the private network address information associated with the UE includes a second IP address and a second port number. In an aspect of the disclosure, the method further includes: assigning an identifier to the UE; and transmitting the identifier of the UE to the application server, wherein the mapping between the private network address information associated with the UE and the public network address information associated with the UE maps the identifier of the UE to the private network address information associated with the UE and the public network address information associated with the UE.

In an aspect of the disclosure, a method of wireless communication for an apparatus includes: receiving, from a user equipment (UE), a message including at least one user plane data packet; determining public network address information of the UE based on the message; receiving, from a network address translation (NAT) device, private network address information associated with the UE; receiving, from an application server in an edge data network, a service request including at least the public network address information associated with the UE, wherein the apparatus includes a mapping between the private network address information associated with the UE and the public network address information associated with the UE; and transmitting, to the application server in the edge data network, a message in response to the service request. In an aspect of the disclosure, the method further includes: determining an identifier of the UE from the public network address information associated with the UE, wherein the mapping between the private network address information associated with the UE and the public network address information associated with the UE maps the identifier of the UE to the private network address information associated with the UE and the public network address information associated with the UE. In an aspect of the disclosure, the identifier of the UE is a generic public subscription identifier (GPSI). In an aspect of the disclosure, the method further includes: assigning an identifier to the UE; and transmitting the identifier to the application server, wherein the mapping between the private network address information associated with the UE and the public network address information associated with the UE maps the identifier to the private network address information associated with the UE and the public network address information associated with the UE.

In an aspect of the disclosure, an apparatus for wireless communication includes: means for receiving a token from a first server in an edge data network; and means for transmitting identification information associated with the apparatus to a second server of the edge data network, wherein the identification information includes at least the token, an identifier of the apparatus, and an identifier of the first server, wherein the identifier of the apparatus is independent of an Internet Protocol (IP) address of the apparatus. In an aspect of the disclosure, the identifier of the apparatus is a generic public subscription identifier (GPSI). In an aspect of the disclosure, the first server is an edge application server (EAS) and the second server is an edge enabler server (EES). In an aspect of the disclosure, the identification information is associated with an identifier of an edge enabler client (EEC) in the apparatus.

In an aspect of the disclosure, an apparatus for wireless communication includes: means for receiving, from a user equipment (UE), identification information associated with the UE, wherein the identification information includes at least, an identifier of the UE, an identifier of an application server in an edge data network, and a token associated with the application server, wherein the identifier of the UE is independent of an Internet Protocol (IP) address of the UE; means for receiving, from the application server, a service request including at least the token and the identifier of the application server, wherein the apparatus includes a mapping between an edge enabler client identifier (EEC ID), the token, the identifier of the application server, and the identifier of the UE; and means for transmitting, to the application server, a message in response to the service request. In an aspect of the disclosure, the apparatus for wireless communication further includes: means for determining at least one of the EEC ID or the identifier of the UE in response to the service request based on the token, the identifier of the application server, and the mapping between the EEC ID, the token, the identifier of the application server, and the identifier of the UE; and means for executing the service request based on at least one of the EEC ID or the identifier of the UE. In an aspect of the disclosure, the apparatus for wireless communication further includes: means for generating a table including the mapping between the token, the identifier of the application server, and the identifier of the UE. In an aspect of the disclosure, the identifier of the UE is a generic public subscription identifier (GPSI) or the token.

In an aspect of the disclosure, the apparatus for wireless communication further includes: means for assigning a second identifier to the UE; and means for transmitting the second identifier of the UE to the application server, wherein the mapping between the edge enabler client identifier (EEC ID), the token, the identifier of the application server, and the identifier of the UE maps the second UE identifier to the edge enabler client identifier (EEC ID), the token, the identifier of the application server, and the identifier of the UE. In an aspect of the disclosure, the apparatus for wireless communication further includes: means for receiving a network address of a first server configured to provide public network address information associated with the apparatus; means for transmitting, to the first server based on the network address, a request for the public network address information associated with the apparatus; means for receiving the public network address information associated with the apparatus from the first server in response to the request; and means for transmitting, to a second server in an edge data network, the public network address information associated with the apparatus and private network address information associated with the apparatus when network address translation is applied to the private network address information associated with the apparatus. In an aspect of the disclosure, the means for receiving the network address of the first server configured to provide public network address information associated with the apparatus is configured to: receive the network address of the first server from at least one of: an entity in a core network via a parameter in a protocol configuration options (PCO) information element (IE), an edge configuration server (ECS) in an edge data network, or an edge enabler server (EES) in the edge data network. In an aspect of the disclosure, the first server is a Session Traversal Utilities for NAT (STUN) server and the second server is an edge enabler server (EES). In an aspect of the disclosure, the apparatus for wireless communication further includes: means for transmitting an identifier of the apparatus to the second server. In an aspect of the disclosure, the identifier of the apparatus is a generic public subscription identifier (GPSI). In an aspect of the disclosure, the apparatus for wireless communication further includes: means for determining whether network address translation is applied to the private network address information associated with the UE.

In an aspect of the disclosure, an apparatus for wireless communication, includes: means for receiving, from a user equipment (UE), public network address information and private network address information associated with the UE; means for receiving, from an application server in an edge data network, a service request including at least the public network address information associated with the UE, wherein the apparatus includes a mapping between the private network address information associated with the UE and the public network address information associated with the UE; and means for transmitting, to the application server in the edge data network, a message in response to the service request. In an aspect of the disclosure, the apparatus for wireless communication further includes: means for determining the private network address information associated with the UE in response to the service request based on the public network address information associated with the UE and the mapping between the private network address information associated with the UE and the public network address information associated with the UE; and means for executing the service request based on the private network address information associated with the UE.

In an aspect of the disclosure, the apparatus for wireless communication further includes: means for invoking a network exposure function (NEF) application programming interface (API) based on the private network address information associated with the UE. In an aspect of the disclosure, the apparatus for wireless communication further includes: means for transmitting, to the UE, a network address of a server configured to provide the public network address information associated with the UE. In an aspect of the disclosure, the apparatus for wireless communication further includes: means for receiving, from the UE, an identifier of the UE, wherein the mapping between the private network address information associated with the UE and the public network address information associated with the UE maps the identifier of the UE to the private network address information associated with the UE and the public network address information associated with the UE. In an aspect of the disclosure, the identifier of the UE is a generic public subscription identifier (GPSI). In an aspect of the disclosure, the public network address information associated with the UE includes a first Internet Protocol (IP) address and a first port number, and wherein the private network address information associated with the UE includes a second IP address and a second port number. In an aspect of the disclosure, the apparatus for wireless communication further includes: means for assigning an identifier to the UE; and means for transmitting the identifier of the UE to the application server, wherein the mapping between the private network address information associated with the UE and the public network address information associated with the UE maps the identifier of the UE to the private network address information associated with the UE and the public network address information associated with the UE.

In an aspect of the disclosure, an apparatus for wireless communication includes: means for receiving, from a user equipment (UE), a message including at least one user plane data packet; means for determining public network address information of the UE based on the message; means for receiving, from a network address translation (NAT) device, private network address information associated with the UE; means for receiving, from an application server in an edge data network, a service request including at least the public network address information associated with the UE, wherein the apparatus includes a mapping between the private network address information associated with the UE and the public network address information associated with the UE; and means for transmitting, to the application server in the edge data network, a message in response to the service request. In an aspect of the disclosure, the apparatus for wireless communication further includes: means for determining an identifier of the UE from the public network address information associated with the UE, wherein the mapping between the private network address information associated with the UE and the public network address information associated with the UE maps the identifier of the UE to the private network address information associated with the UE and the public network address information associated with the UE. In an aspect of the disclosure, the identifier of the UE is a generic public subscription identifier (GPSI). In an aspect of the disclosure, the apparatus for wireless communication further includes: means for assigning an identifier to the UE; and means for transmitting the identifier to the application server; wherein the mapping between the private network address information associated with the UE and the public network address information associated with the UE maps the identifier to the private network address information associated with the UE and the public network address information associated with the UE.

In an aspect of the disclosure, a computer-readable medium storing computer executable code is provided. The code when executed by a processor cause the processor to: receive a token from a first server in an edge data network; and transmit identification information associated with the apparatus to a second server of the edge data network, wherein the identification information includes at least the token, an identifier of the apparatus, and an identifier of the first server, wherein the identifier of the apparatus is independent of an Internet Protocol (IP) address of the apparatus.

In an aspect of the disclosure, a computer-readable medium storing computer executable code is provided. The code when executed by a processor cause the processor to: receive, from a user equipment (UE), identification information associated with the UE, wherein the identification information includes at least, an identifier of the UE, an identifier of an application server in an edge data network, and a token associated with the application server, wherein the identifier of the UE is independent of an Internet Protocol (IP) address of the UE; receive, from the application server, a service request including at least the token and the identifier of the application server, wherein the apparatus includes a mapping between an edge enabler client identifier (EEC ID), the token, the identifier of the application server, and the identifier of the UE; and transmit, to the application server, a message in response to the service request.

In an aspect of the disclosure, a computer-readable medium storing computer executable code is provided. The code when executed by a processor cause the processor to: receive a network address of a first server configured to provide public network address information associated with the apparatus; transmit, to the first server based on the network address, a request for the public network address information associated with the apparatus; receive the public network address information associated with the apparatus from the first server in response to the request; and transmit, to a second server in an edge data network, the public network address information associated with the apparatus and private network address information associated with the apparatus when network address translation is applied to the private network address information associated with the apparatus.

In an aspect of the disclosure, a computer-readable medium storing computer executable code is provided. The code when executed by a processor cause the processor to: receive, from a user equipment (UE), at least public network address information associated with the UE; receive, from an application server in an edge data network, a service request including at least the public network address information associated with the UE, wherein the apparatus includes a mapping between private network address information associated with the UE and the public network address information associated with the UE; and transmit, to the application server in the edge data network, a message in response to the service request.

In an aspect of the disclosure, a computer-readable medium storing computer executable code is provided. The code when executed by a processor cause the processor to: receive, from a user equipment (UE), a message including at least one user plane data packet; determine public network address information of the UE based on the message; receive, from a network address translation (NAT) device, private network address information associated with the UE; receive, from an application server in an edge data network, a service request including at least the public network address information associated with the UE, wherein the apparatus includes a mapping between the private network address information associated with the UE and the public network address information associated with the UE; and transmit, to the application server in the edge data network, a message in response to the service request.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 is a diagram illustrating an example network architecture including a UE, a radio access network, a core network, a network address translation (NAT) device, and an edge data network.

FIG. 5 is a diagram illustrating an example network architecture including a UE, a radio access network, a core network, a network address translation (NAT) device, and an edge data network.

FIG. 6 is a signal flow diagram in accordance with various aspects of the present disclosure.

FIG. 7 is a diagram illustrating an example network architecture including a UE, a core network, a Session Traversal Utilities for NAT (STUN) server, and an edge data network.

FIG. 8 (including FIGS. 8A and 8B) illustrates a signal flow diagram in accordance with various aspects of the present disclosure.

FIG. 9 is a diagram illustrating an example network architecture including a UE, a core network, a NAT server, and an edge data network.

FIG. 10 illustrates a signal flow diagram in accordance with various aspects of the present disclosure.

FIG. 11 is a flowchart of a method of wireless communication.

FIG. 12 is a flowchart of a method of wireless communication.

FIG. 13 is a conceptual data flow diagram illustrating the data flow between different means/components in an example apparatus.

FIG. 14 is a diagram illustrating an example of a hardware implementation for an apparatus employing a processing system.

FIG. 15 is a flowchart of a method of wireless communication.

FIG. 16 is a flowchart of a method of wireless communication.

FIG. 17 is a flowchart of a method of wireless communication.

FIG. 18 is a conceptual data flow diagram illustrating the data flow between different means/components in an example apparatus.

FIG. 19 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

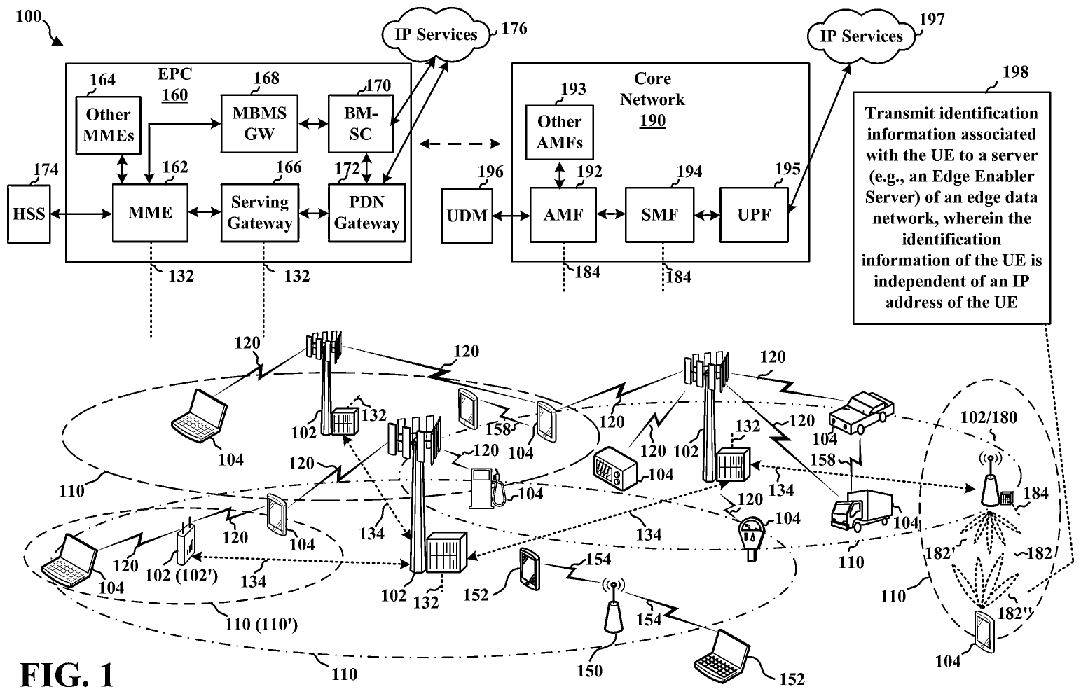

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to transmit identification information associated with the UE 104 to a server (e.g., an Edge Enabler Server) of an edge data network, wherein the identification information of the UE 104 is independent of an IP address of the UE 104 (198).

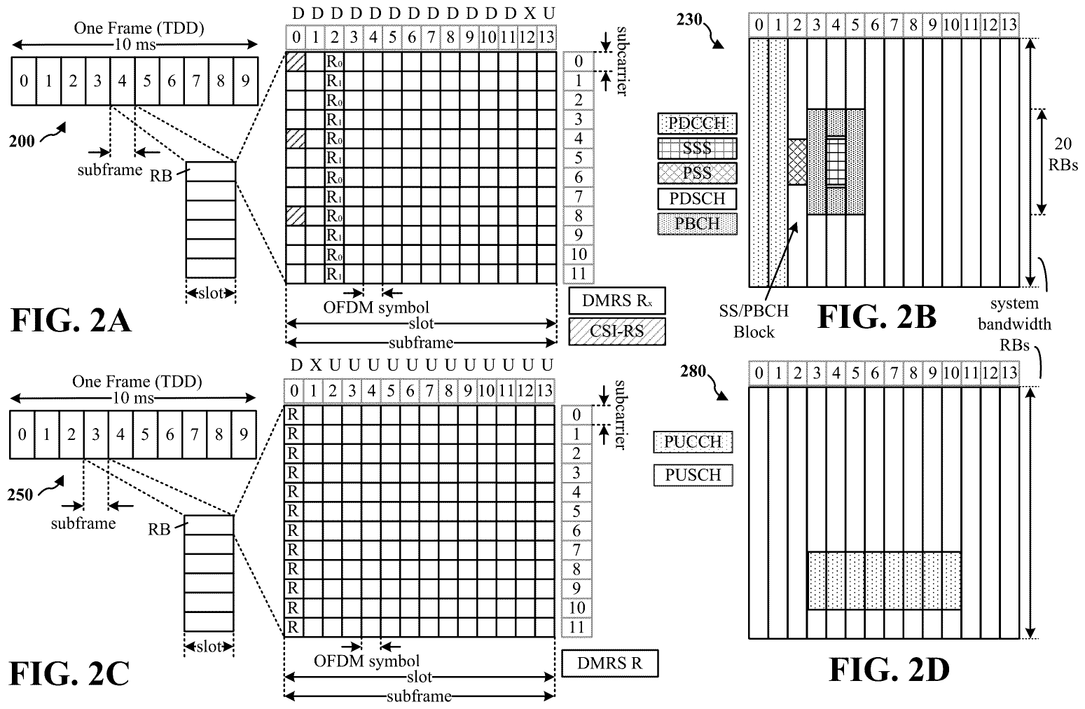

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

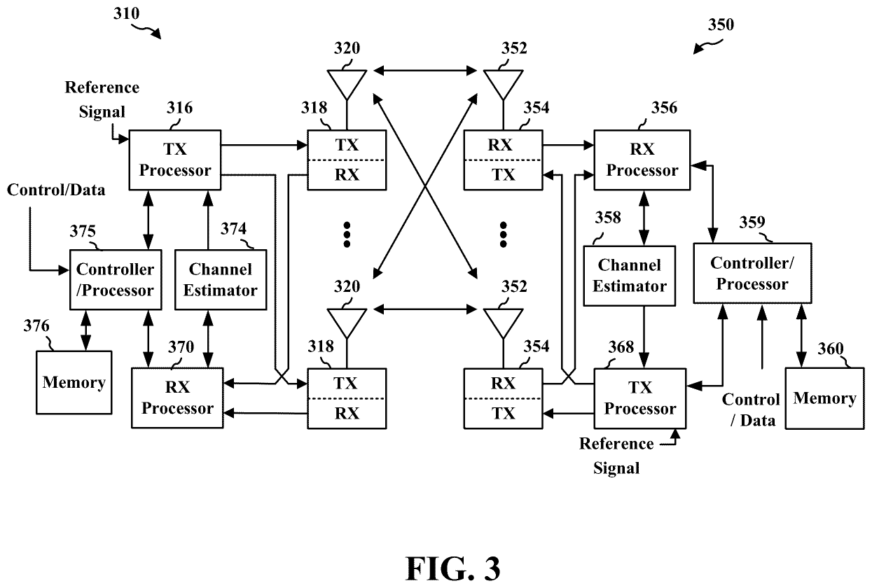

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

When mobile network operators do not have sufficient public Internet Protocol (IP) addresses (e.g., public IPv4 addresses) available to assign to UEs, the mobile network operators may assign private IP addresses (e.g., private IPv4 addresses) to the UEs. For example, a unique private IPv4 address may be assigned to a modem of each UE. Since the private IP addresses may not be known to networks (e.g., the Internet) outside of the mobile network, the private IP addresses of the UEs may need to be mapped to public IP addresses via network address translation (NAT). The core network (CN) of a mobile network, however, may not perform network address translation (NAT) and may not be aware of the public IP addresses of the UEs. Moreover, entities in a UE (e.g., a modem, an Edge Enabler Client (EEC), an Application Client (AC)) may not be aware of the public IP address of the UE.

In edge computing, entities in an edge data network, such as an Edge Application Server (EAS) and an Edge Enabler Server (EES), may communicate using one or more application programming interfaces (APIs) (also referred to as EDGEAPP APIs). EDGEAPP APIs defined between the EAS and the EES typically use the IP address of a UE as an API key. For example, an entity in the edge data network may obtain the IP address of a UE from the Application Client (AC) or the Edge Enabler Client (EEC) of the UE. The EEC and EES may not use the IP address of a UE to identify the EEC.

Therefore, in some scenarios where network address translation (NAT) is deployed between the mobile network (e.g., a 3GPP core network (CN)) and the edge data network, the EEC may provide the private IP address of the UE to the EES, and the EAS may only know the public IP address of the UE from data packets received from the Access Client (AC) (e.g., due to the network address translation (NAT)). In these scenarios, the mismatch of public and private IP addresses of the UE at the EAS and EES may prevent the functionality of EDGEAPP APIs between the EAS and EES.

Application service providers typically do not identify a UE based on the IP address of the UE because the IP address of the UE can be changed at any time (e.g., Wi-Fi to cellular transition). In some examples, an EAS and a user (e.g., a UE) may exchange a token when the user initially accesses a service supported by the EAS. For example, the token may be a unique value (e.g., a unique alphanumeric value) based on log-in information, such as a username and/or password created by the user. Thereafter, the edge data network may identify the user (e.g., a UE) with the token.

In some examples, if the EAS and the EES at the edge data network can identify the EEC of the UE with the token exchanged between the Application Client (AC) and the EAS, the issues associated with identifying the UE at the edge data network using a public IP address of the UE (e.g., when NAT is deployed between the core network (CN) and the edge data network) may be overcome. In some examples, if the EAS and the EES can identify the EEC of the UE with the public IP address of the EEC the issues associated with identifying the UE at the edge data network using a public IP address of the UE (e.g., when NAT is deployed between the core network (CN) and the edge data network) may be overcome.

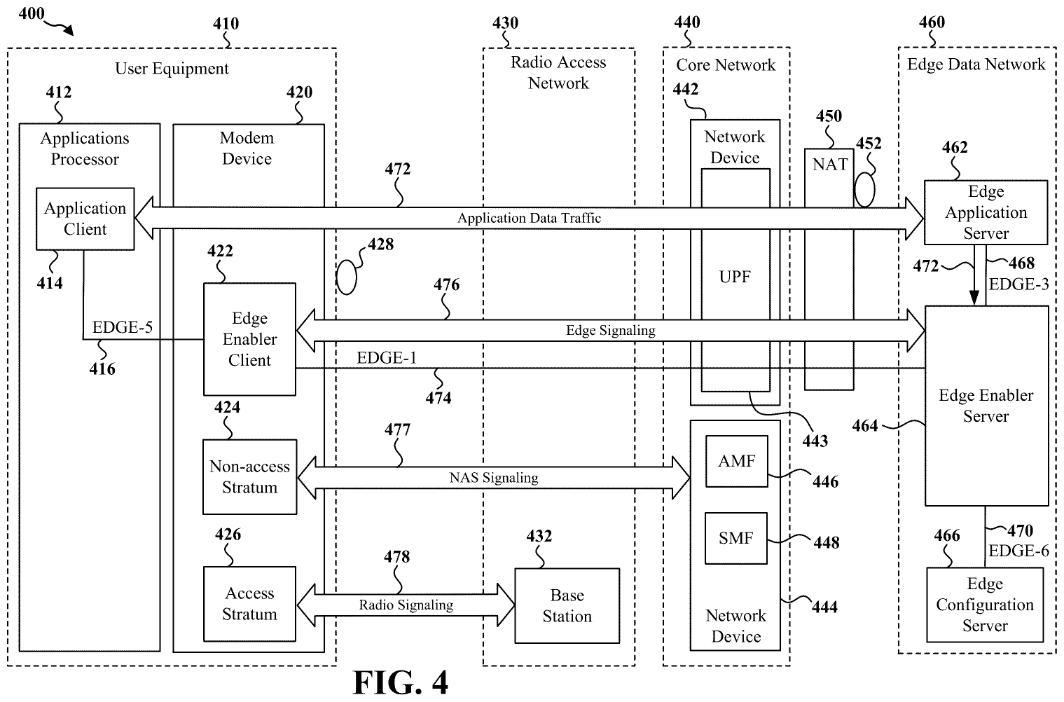

FIG. 4 is a diagram illustrating an example network architecture 400 including a user equipment (UE) 410, a radio access network 430, a core network 440, a network address translation (NAT) server 450, and an edge data network 460.

The UE 410 includes an applications processor 412 and a modem device 420. The applications processor 412 includes an application client (AC) 414, and the modem device 420 includes an edge enabler client (EEC) 422, a non-access stratum (NAS) protocol layer 424, and an access stratum protocol layer 426. The EDGE-5 reference point 416 (also referred to as an EDGE-5 interface) enables interactions between the application client (AC) 414 and the edge enabler client (EEC) 422.

The application client (AC) 414 may be an application that runs in the applications processor 412 and performs a client function. The Edge Enabler Client (EEC) 422 provides supporting functions needed for the application client (AC) 414. For example, the supporting functions may include retrieval and provisioning of configuration information to enable the exchange of Application Data Traffic 472 with the Edge Application Server (EAS) 462, and discovery of Edge Application Servers (EASs) available in the edge data network 460.

The radio access network 430 includes at least one base station, such as the base station 432. The UE 410 and the base station 432 may communicate data via radio signaling 478.

The core network 440 includes a first network device 442 (also referred to as a first network node) and a second network device 444 (also referred to as a second network node). In some examples, the core network 440 may be a 3GPP core network. The first network device 442 implements a user plane function (UPF) 443 and the second network device 444 implements an access and mobility management function (AMF) 446 and a session management function (SMF) 448. The UE 410 may communicate control information with the AMF 446 and/or the SMF 448 via NAS signaling 477.

The edge data network 460 may include an Edge Application Server (EAS) 462, an Edge Enabler Server (EES) 464, and an Edge Configuration Server (ECS) 466. The EAS 462 may be an application server in the edge data network 460 configured to perform server functions. The application client (AC) 414 may connect to the EAS 462 to access the features of edge computing. In some examples, the EAS 462 may interact with the core network 440 by directly invoking core network function APIs (e.g., if it is an entity trusted by the core network 440) and/or invoking core network capabilities through the EES 464.

The EES 464 provides supporting functions for the EAS 462 and the Edge Enabler Client (EEC) 422. For example, the EES 464 may provision configuration information to the Edge Enabler Client (EEC) 422 and may enable exchange of application data traffic with the EAS 462. The EEC 422 and the EES 464 may communicate via Edge signaling 476 over the EDGE-1 reference point 474.

In some examples, the EES 464 supports the functionalities of an API invoker and an API exposing function. In some examples, the EES 464 supports external exposure of the core network 440 and service capabilities to the EAS 462 over an EDGE-3 reference point 468. In some examples, the EES 464 supports functions associated with registration, such as a registration procedure, a registration update, and/or a de-registration operation, for the Edge Enabler Client (EEC) 422 and the EAS 462.

The Edge Configuration Server (ECS) 466 provides supporting functions for the Edge Enabler Client (EEC) 422 to connect with the EES 464. In some examples, the Edge Configuration Server (ECS) 466 provisions Edge configuration information to the Edge Enabler Client (EEC) 422. For example, the Edge configuration information may include information for the Edge Enabler Client (EEC) 422 to connect to the EES 464 and/or the information for establishing a connection with the EES 464 (such as a Uniform Resource Identifier (URI)). In some examples, the Edge Configuration Server (ECS) 466 supports functions associated with registration, such as a registration procedure, a registration update, and/or a de-registration operation, for the EES 464.

The UE 410 may be assigned a private network address 428 (e.g., a private Internet Protocol (IP) address and port number), which may be network address translated via the network address translation (NAT) server 450. The translated network address may serve as the public network address 452 (e.g., a public Internet Protocol (IP) address and port number) of the UE 410. In some examples, the UE 410 may be aware of its private network address, but not its public network address 452. For example, entities in the UE 410, such as the AC 414 and EEC 422, may be aware of the private network address 428 and may not be aware of the public network address 452.

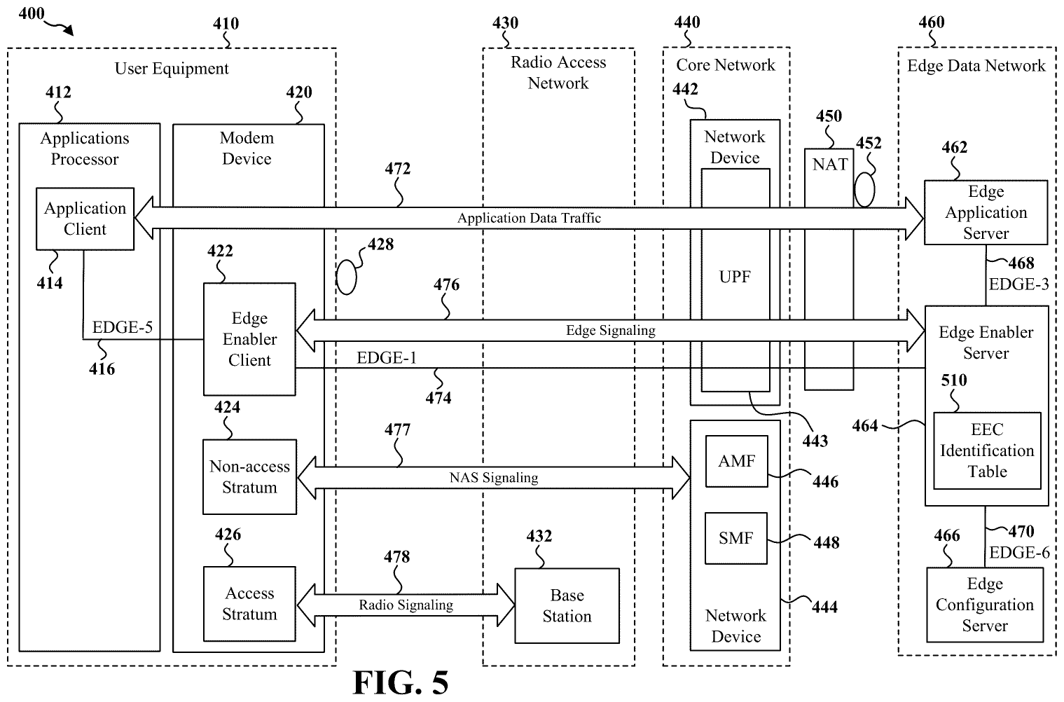

FIG. 5 is a diagram illustrating the example network architecture of FIG. 4 (e.g., the edge data network architecture 400) including the UE 410, the radio access network 430, the core network 440, the network address translation (NAT) server 450, and the edge data network 460. In some examples, and as described in detail herein, the EES 464 may generate an EEC identification table that includes a mapping between at least the private and public network addresses of the UE 410. As shown in FIG. 5, for example, the EES 464 may generate the EEC identification table 510.

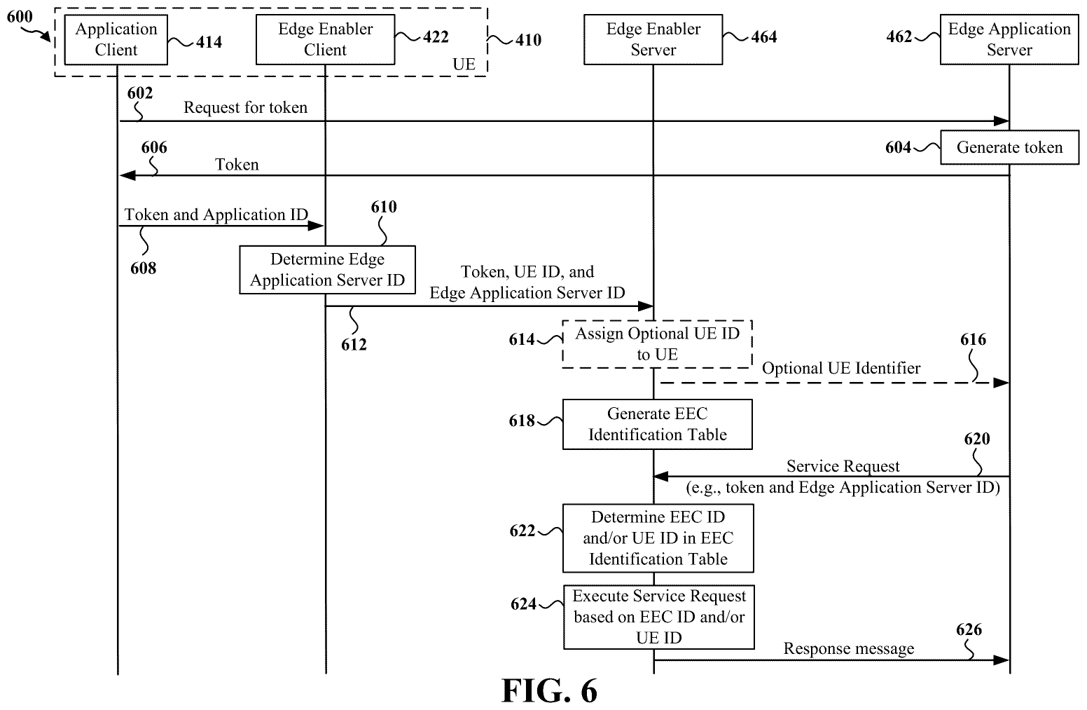

FIG. 6 is a signal flow diagram 600 in accordance with various aspects of the present disclosure. The signal flow diagram 600 includes the UE 410, the EES 464, and the EAS 462. The UE 410 includes the AC 414 and the EEC 422.

The AC 414 transmits a message 602 including a request for a token to the EAS 462. In some examples, the request for the token may be initiated using a network API for anonymous customer reference management (e.g., NetAPI: ACR). At 604, the EAS 462 generates the token. In some examples, the token may be an open mobile alliance (OMA) anonymous customer reference (ACR) (abbreviated herein as OACR). In these examples, the EAS 462 may generate the token by assigning an OACR to the AC 414. The EAS 462 transmits a message 606 including the token (e.g., OACR) to the AC 414.

The AC 414 receives the message 606 including the token and transmits a message 608 including the token and an application identifier (ID) to the EEC 422 over the EDGE-5 API 416 (also referred to as an EDGE-5 reference point). In some examples, the message 608 may include an information element (IE) containing the token, the application identifier (ID), and an identifier (ID) of the EAS 462 (also referred to as an Edge Application Server ID and EAS ID). The EEC 422 receives the message 608 and, at 610, determines the identifier (ID) of the EAS 462 based on the information element (IE) in the message 608.

The EEC 422 may transmit a message 612 including the token, an identifier of the UE 410 (also referred to as a UE Identifier and UE ID), and the identifier of the EAS 462. For example, the EEC 422 may transmit the message 612 to the EES 464. In some examples, the identifier of the UE 410 may be a Generic Public Subscription Identifier (GPSI) associated with the UE 410. The GPSI is a public identifier that may be used both inside and outside of a 3GPP system (e.g., the radio access network 430 and the core network (CN) 440 in FIG. 5). For example, the GPSI may be used for addressing a subscription in different data networks outside of the core network (CN) 440. In some examples, the GPSI may be a mobile subscriber Integrated Services Digital Network (ISDN) number (MSISDN) or an external identifier. In some examples, the EEC 422 may provide the GPSI via an Edge Application Server (EAS) discovery API or a new API. In some scenarios, if the Edge Enabler Client (EEC) 422 does not provide a GPSI associated with the UE 410, the EES 464 may trigger an API for obtaining the GPSI (e.g., IP addr-GPSI translation API).

At 614, the EES 464 may assign an optional identifier to the UE 410 (also referred to herein as an optional UE identifier, optional UE ID, and Edge UE ID). The EES 464 may transmit a message 616 including the optional identifier of the UE 410 to the EAS 462. In some examples, the EES 464 may transmit the message 616 including the optional identifier of the UE 410 when the EAS 462 invokes an API defined between the EES 464 and the EAS 462, such as an API for requesting the identity of the UE 410 (e.g., an identifier of the UE 410). The EAS 462 may use the optional identifier of the UE 410 when invoking other APIs defined between the EES 464 and the EAS 462. These APIs defined between the EES 464 and the EAS 462 may be referred to as EDGE-3 APIs. In some examples, the optional identifier of the UE 410 may be the GPSI of the UE 410 or the token in the message 612.

At 618, the EES 464 generates an EEC identification table (e.g., the EEC identification table 510 in FIG. 5). In some examples, the EEC identification table may include one or more EEC IDs and a mapping between each EEC ID and a corresponding token, identifier of an EAS, and/or an identifier of a UE. In some aspects of the disclosure, an optional identifier of a UE may be mapped to an EEC ID in the EEC identification table. In some examples, different tokens or different UE IDs (EEC ID, Edge UE ID) can address the same UE. An example EEC identification table generated at 618 is shown in Table 1.

TABLE 1

| | | | | Optional UE ID |
|---|---|---|---|---|
| EEC ID | Token | EAS ID | UE ID | (e.g., Edge UE ID) |
| EEC ID1 | OACR1 | EAS ID1 | 918369110173 | 1 |
| EEC ID2 | OACR2 | EAS ID2 | 123@berlin.de | 2 |
| EEC ID3 | OACR3 | EAS ID3 | 456@seoul.kr | 3 |
| EEC ID3 | OACR4 | EAS ID4 | 789@sandiego.us | 3 |

In Table 1, each row indicates a mapping between an identifier of an EEC (EEC ID) in a UE, and a corresponding token, identifier of an EAS (EAS ID), and an identifier of the UE (UE ID). As shown in Table 1, an optional identifier of the UE (e.g., an Edge UE ID) may be mapped to the EEC ID.

In one example scenario, with reference to Table 1 and FIG. 6, the identifier of the EEC 422 in the UE 410 may be represented as “EEC ID1”, the token in the message 612 may be represented as “OACR1”, the identifier of the EAS 462 (EAS ID) may be represented as “EAS ID1”, the identifier of the UE 410 may be represented as “918369110173”, and the optional identifier of the UE 410 (e.g., the Edge UE ID) may be represented as “1.” As described herein, for example, the EES 464 may receive the token (e.g., OACR1), the identifier of the EAS 462 (e.g., EAS ID1), and the identifier of the UE 410 (e.g., 918369110173) in the message 612.

As shown in FIG. 6, the EAS 462 may transmit a message 620 including a service request. In some examples, the service request may invoke an API defined between the EAS 462 and the EES 464 (also referred to as an EDGE-3 API). The EAS 462 may include at least the token and the identifier of the EAS 462 (EAS ID) in the message 620 to enable execution of the API at the EES 464.

At 622, the EES 464 may determine the identifier of the EEC 422 and/or the identifier of the UE 410 based on the EEC identification table (e.g., the example, EEC identification table shown in Table 1), and the token and the identifier of the EAS 462 (EAS ID) included in the message 620. For example, the EES 464 may match the token and the identifier of the EAS 462 (EAS ID) received in the message 620 to a token and an identifier of an EAS (EAS ID) in the EEC identification table. In one example, with reference to Table 1, if the token and the identifier of the EAS 462 (EAS ID) received in the message 620 are “OACR1” and EAS ID1”, respectively, the EES 464 may find “OACR1” and “EAS ID1” in Table 1 and may determine that the EEC ID corresponding to “OACR1” and “EAS ID1” is “EEC ID1.” In some examples, the EES 464 may determine that the UE ID corresponding to “OACR1” and “EAS ID1” is “918369110173.” In some examples, the EES 464 may determine that the optional UE ID (e.g., the Edge UE ID) corresponding to “OACR1” and “EAS ID1” is “1.” It should be noted that neither a public IP address nor a private IP address of the UE 410 is used at the EES 464 to identify the UE 410.

At 624, the EES 464 may execute the service request from the EAS 462 based on the identifier of the EEC 422 (e.g., the identifier of the EEC 422 determined at 622). In other examples, the EES 464 may execute the service request from the EAS 462 based on the identifier of the EEC 422 (e.g., the identifier of the EEC 422 determined at 622) and/or the identifier of the UE 410. The EES 464 may transmit a message 626 to the EAS 462 in response to the service request in the message 620.

An example of a service request from the EAS 462 will now be described. In one example, the service request in the message 620 may be an EDGE-3 API for requesting the location of the UE 410. In response to the service request, the EES 464 may determine the identifier of the EEC 422 (e.g., EEC ID1) and the identifier of the UE 410 (e.g., a GPSI value 918369110173) from the EEC identification table (e.g., Table 1), and may execute a 3GPP network API for obtaining the location of the UE 410 using the identifier of the UE 410 (e.g., a GPSI value 918369110173). The 3GPP network may return information indicating the location of the UE 410 and the identifier of the UE 410. The EES 464 may include the information indicating the location of the UE 410 in the response message 626.

In some examples, the mapping in an EEC identification table (e.g., Table 1) between an EEC ID and a corresponding token, identifier of an EAS, and/or an identifier of a UE may remain valid as long as the token between the AC (e.g., the AC 414) and the EAS (e.g., the EAS 462) remains valid. In some examples, the EES 464 may use the GPSI corresponding to the EEC ID when the EES 464 triggers a network exposure function (NEF) application programming interface (API) for the EEC 422.

In some scenarios, if a session between the AC 414 and the EAS 462 is released, or if the token (e.g., an OACR) exchanged between the AC 414 and the EAS 462 expires, then 602 through 618 in FIG. 6 may be repeated to update the EEC identification table.

In some scenarios, the EEC 422 may not be able to provide a GPSI to the EES 464. In these scenarios, the EES 464 may apply an API (e.g., an SA2 NEF GPSI-IP address translation API) configured to provide the GPSI of the EEC 422 based on the IP address of the EEC 422. However, if a network address translation (NAT) server is implemented between the core network and the edge data network, such API may not provide the GPSI since the API needs a non-translated (e.g., non-NATed) IP addresses. The aspects described herein may overcome such issues arising from implementation of network address translation (NAT) between the core network and the edge data network

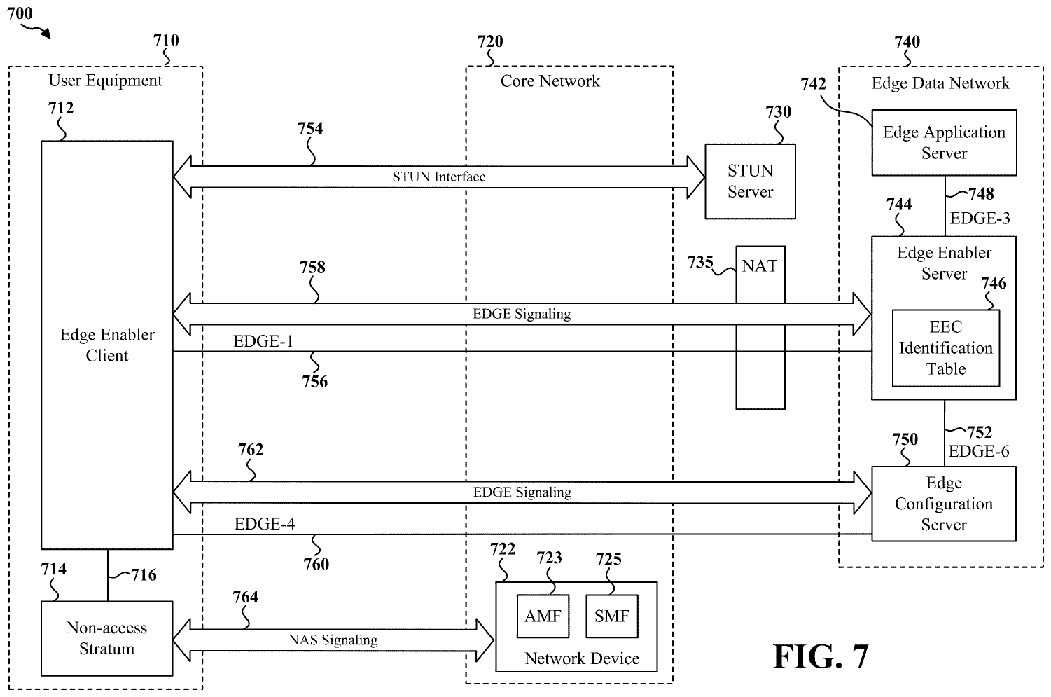

FIG. 7 is a diagram illustrating an example network architecture 700 including a user equipment (UE) 710, a core network 720, a Session Traversal Utilities for NAT (STUN) server 730, and an edge data network 740.

The UE 710 includes an edge enabler client (EEC) 712 and a non-access stratum (NAS) protocol layer 714. The UE 710 may include additional components which have been omitted for ease of description, such as an applications processor, and a modem device in which the EEC 712 may reside.

The EEC 712 provides supporting functions needed for an application client in the UE 710. For example, the supporting functions may include retrieval and provisioning of configuration information to enable the exchange of application data traffic with the EAS 742, and discovery of EASs available in the edge data network 740.

The core network 720 includes a network device 722 (also referred to as a network node). In some examples, the core network 720 may be a 3GPP core network. The network device 722 implements an access and mobility management function (AMF) 723 and a session management function (SMF) 725. The UE 710 may communicate control information with the AMF 723 and/or the SMF 725 via NAS signaling 764.

The edge data network 740 may include an Edge Application Server (EAS) 742, an Edge Enabler Server (EES) 744, and an Edge Configuration Server (ECS) 750. The EAS 742 may be an application server in the edge data network 740 configured to perform server functions. An application client in the UE 710 may connect to the EAS 742 to access the features of edge computing. In some examples, the EAS 742 may interact with the core network 720 by directly invoking core network function APIs (e.g., if it is an entity trusted by the core network 720) and/or invoking core network capabilities through the EES 744.

The EES 744 provides supporting functions for the EAS 742 and the EEC 712. For example, the EES 744 may provision configuration information to the EEC 712 and may enable exchange of application data traffic with the EAS 742. In some examples, the EES 744 supports the functionalities of an API invoker and an API exposing function. In some examples, the EES 744 supports external exposure of the core network 720 and service capabilities to the EAS 742 over an EDGE-3 reference point 748. In some examples, the EES 744 supports functions associated with registration, such as a registration procedure, a registration update, and/or a de-registration operation, for the EEC 712 and the EAS 742.

The ECS 750 provides supporting functions for the EEC 712 to connect with the EES 744. In some examples, the ECS 750 provisions Edge configuration information to the EEC 712. For example, the Edge configuration information may include information for the EEC 712 to connect to the EES 744 and/or the information for establishing a connection with the EES 744 (such as a Uniform Resource Identifier (URI)). In some examples, the ECS 750 supports functions associated with registration, such as a registration procedure, a registration update, and/or a de-registration operation, for the EES 744. The ECS 750 may communicate with the EES 744 via the EDGE-6 reference point 752.

The UE 710 may be assigned a private network address (e.g., a private Internet Protocol (IP) address and port number), which may be network address translated via the network address translation (NAT) server 735. The translated network address may serve as the public network address (e.g., a public Internet Protocol (IP) address and port number) of the UE 710. In some examples, the UE 710 may be aware of its private network address, but not its public network address. For example, entities in the UE 710, such as the EEC 712, may be aware of the private network address and may not be aware of the public network address.

In some examples, and as described in detail herein, the EES 744 may generate an EEC identification table that includes a mapping between at least the private and public network addresses of the UE 710. For example, as shown in the edge data network architecture 700, the EES 744 may generate the EEC identification table 746.

The EEC 712 may communicate with the STUN server 730 via the STUN interface 754. For example, the STUN interface 754 may use a STUN protocol, which may enable a client (e.g., the EEC 712) to discover the presence and type of NATs between the client and an external network (e.g., the Internet). In some examples, the STUN server 730 may enable the client to discover the mapping between the private network address information (e.g., private IP address and port number) of the client and the corresponding public network address information (e.g., public IP address and port number) of the client.

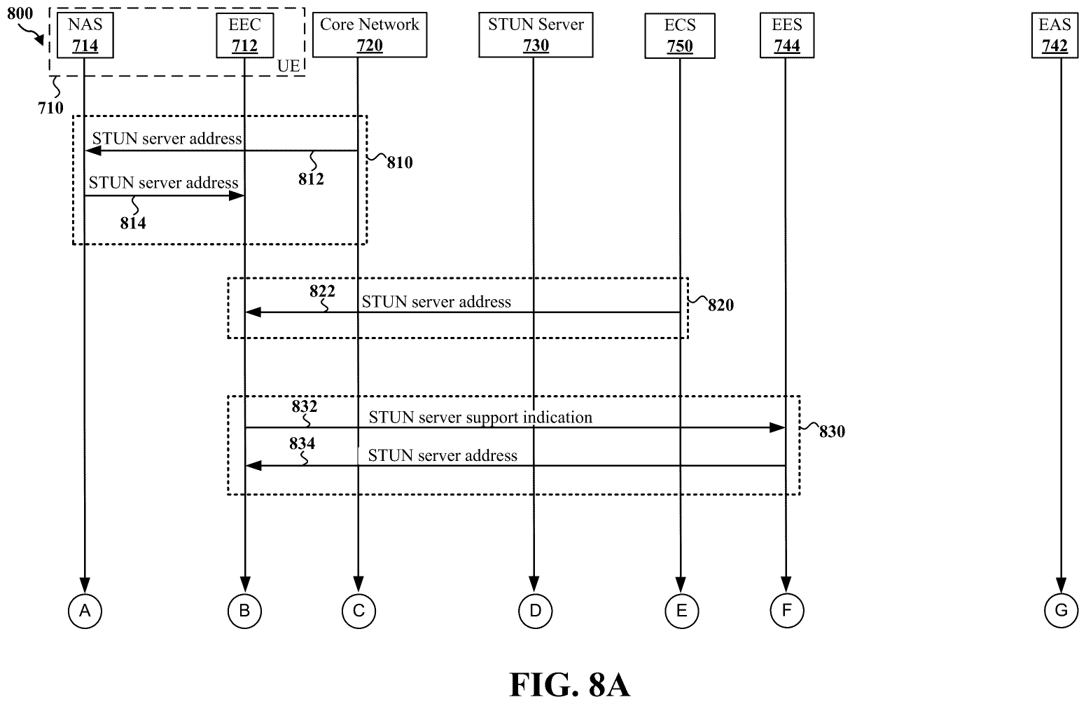

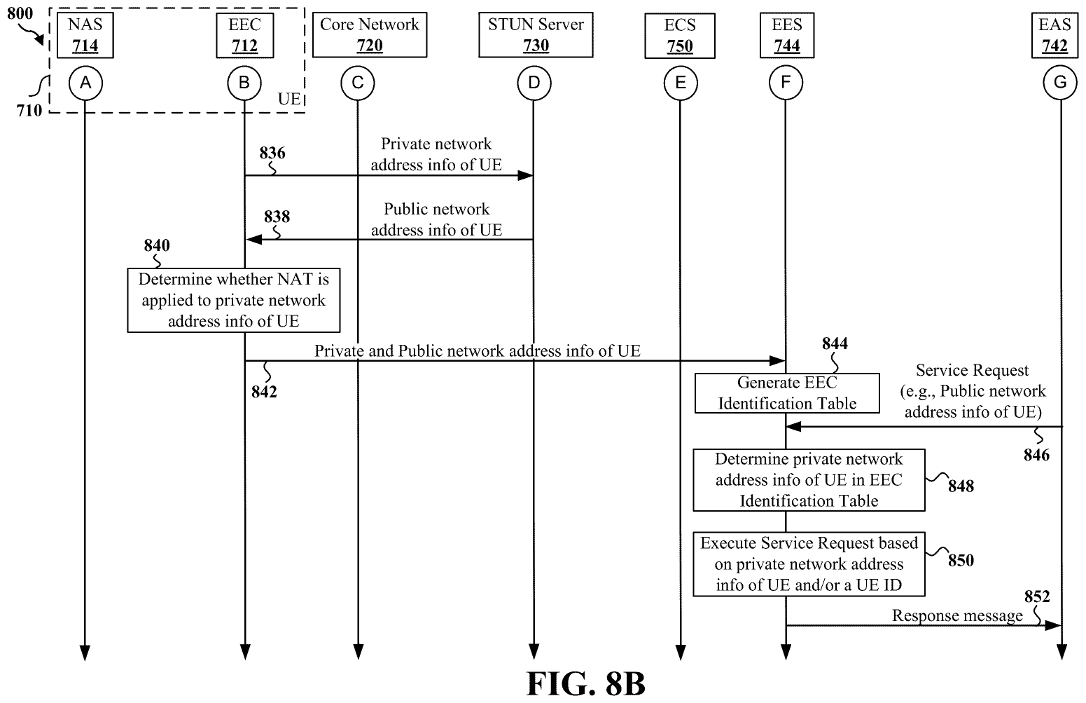

FIG. 8 (including FIGS. 8A and 8B) illustrates a signal flow diagram 800 in accordance with various aspects of the present disclosure. The signal flow diagram 800 includes the UE 710, the core network 722, the STUN server 730, the EAS 742, the EES 744, and the ECS 750. The UE 710 includes the NAS protocol layer 714 and the EEC 712.

The signal flow diagram 800 includes optional communications 810, 820, 830 for provisioning of the network address of the STUN server 730 (also referred to as a STUN server address) to the UE 710. Therefore, it should be understood that if one of the optional communications 810, 820, 830 is performed and the UE 710 is able to receive the network address of the STUN server 730, then the remaining optional communications may not need to be performed. For example, if the UE 710 is able to receive the network address of the STUN server 730 using optional communications 810, then optional communications 820, 830 may be skipped.

In one example, with reference to the optional communications 810 in FIG. 8A, the core network 720 may provide the network address of the STUN server 730 to the EEC 712 on the NAS protocol layer 714 via the NAS message 812. The EEC 712 may then receive the network address of the STUN server 730 via the NAS message 814. In some examples, an entity in the core network 720 (e.g., the AMF and/or SMF) may include the network address of the STUN server 730 in the NAS message 812 using a new parameter in a protocol configuration options (PCO) information clement (IE). In some examples, the NAS message 814 including the network address of the STUN server 730 may be a NAS (upper layer) AT command (e.g., a modem command).

In another example, with reference to the optional communications 820 in FIG. 8A, the ECS 750 may provide the network address of the STUN server 730 to EEC 712 in a message 822 during a service provisioning procedure. In some examples, with reference to FIG. 7, the ECS 750 may transmit the message 822 using Edge signaling 762 over the EDGE-4 reference point 760.

In another example, with reference to the optional communications 830 in FIG. 8A, the EEC 712 may transmit a message 832 including an indication for STUN server support (also referred to as a STUN server support indication) to the EES 744. In some examples, the EES 744 may be preconfigured with the network address of the STUN server 730, may be provisioned with the network address of the STUN server 730, or may be configured to fetch the network address of the STUN server 730. The EES 744 may transmit a message 834 including the network address of the STUN server 730 in response to the message 832. In some examples, the messages 832, 834 may be exchanged between the EEC 712 and the EES 744 during a registration procedure of the EEC 712 with the EES 744. In some examples, with reference to FIG. 8A, the EEC 712 and the EES 744 may exchange the messages 832, 834 using Edge signaling 758 over the EDGE-1 reference point 756.

With reference to FIG. 8B, the EEC 712 of the UE 710 may transmit a message 836 including the private network address information associated with the UE 710 to the STUN server 730. For example, the EEC 712 may transmit the message 836 to the STUN server 730 using the network address of the STUN server received via one of the optional communications 810, 820, 830. The STUN server 730 may transmit a message 838 to the EEC 712 using the private network address information associated with the UE 710, where the message 838 includes the public network address information associated with the UE 710. In some examples, the public network address information associated with the UE 710 includes a first Internet Protocol (IP) address and a first port number, and the private network address information associated with the UE 710 includes a second IP address and a second port number.

At 840, the EEC 712 determines whether network address translation (NAT) is applied to the private network address information associated with the UE 710. In some examples, the EEC 712 may compare the private network address information associated with the UE 710 to the public network address information in the message 838. If the private network address information associated with the UE 710 matches the public network address information in the message 838, the EEC 712 may determine that no network address translation (NAT) is applied. If the private network address information associated with the UE 710 does not match the public network address information in the message 838, the EEC 712 may determine that network address translation (NAT) is applied.

The UE 710 may transmit a message 842 to the EES 744. In some examples, the EEC 712 may include both the private network address information associated with the UE 710 and the public network address information associated with the UE 710 when the EEC 712 has determined (e.g., at 840) that network address translation (NAT) is applied. In other examples, the EES 744 may include the private network address information associated with the UE 710 when the EEC 712 has determined (e.g., at 840) that network address translation (NAT) is not applied.

In some examples, the message 842 may further include a first identifier of the UE 710 (also referred to as UE ID_1). In some examples, the first identifier of the UE 710 may be a GPSI of the UE 710. If the EEC 712 does not include the first identifier of the UE 710 (e.g., a GPSI of the UE 710) in the message 842, the EES 744 may trigger a GPSI translation API with the core network 720 using the private network address information associated with the UE 710 as a key for the GPSI translation API.

In some examples, the EEC 712 may transmit the message 842 during an EAS discovery procedure with the EES 744, during a registration procedure with the EES 744, and/or via one or more new EDGE-1 APIs. For example, the one or more new EDGE-1 APIs may include an API for identifying the EEC 712 (also referred to as an EEC identifier API).

At 844, the EES 744 generates an EEC identification table. In some examples, the EEC identification table may include one or more private network address information entries (e.g., a private Internet Protocol (IP) address and port number) and a mapping between each private network address information entry and a corresponding public network address information entry (e.g., a public Internet Protocol (IP) address and port number). In some examples, the EEC identification table may optionally include the first identifier of the UE 710 (also referred to as UE ID_1) and/or a second identifier of the UE 710 (also referred to as UE ID_2).

In some examples, the second identifier of the UE 710 (e.g., UE ID_2) may be an Edge UE ID assigned by the EES 744. For example, the EES 744 may assign the Edge UE ID to the UE 710 and may provide the Edge UE ID to the EAS 742. In some examples, the EES 744 may provide the Edge UE ID to the EAS 742 when the EAS 742 invokes an API defined between the EES 744 and the EAS 742 for requesting the identity of the UE 710 (e.g., an identifier of the UE 710). In some examples, the EAS 742 may use the Edge UE ID of the UE 710 when invoking other APIs defined between the EES 744 and the EAS 742. These APIs defined between the EES 744 and the EAS 742 may be referred to as EDGE-3 APIs. In some examples, the Edge UE ID of the UE 710 may be the GPSI of the UE 710.

The first identifier of the UE 710 and/or the second identifier of the UE 710 may be mapped to a private network address information entry in the EEC identification table. An example EEC identification table generated at 844 is shown in Table 2.

TABLE 2

| UE private | UE public | UE ID_1 | UE ID_2 |
|---|---|---|---|
| network address info | network address info | (optional) | (optional) |
| 192.168.1.1:1111 | 190.1.1.1:1111 | 918369110173 | 1 |
| 192.168.1.2:1113 | 190.1.1.1:1114 | 123@berlin.de | 2 |
| 192.168.1.3:1811 | 190.1.1.3:1811 | 456@seoul.kr | 3 |
| 192.168.1.4:1711 | 190.1.1.4:1711 | 789@sandiego.us | 4 |

In Table 2, each row indicates a mapping between private network address information of a UE and the corresponding public network address information of the UE. As shown in Table 2, a first optional identifier of the UE (e.g., UE ID_1) and a second optional identifier of the UE (e.g., UE ID_2) may be mapped to the private network address information of that UE.

In one example scenario, with reference to Table 2 and FIG. 8, the private network address information of the UE 710 may include a private Internet Protocol (IP) address and port number represented as “192.168.1.1:1111”, a public Internet Protocol (IP) address and port number represented as “190.1.1.1:1111”, a first identifier of the UE 710 (e.g., UE ID_1) represented as “918369110173”, and a second identifier of the UE 710 (e.g., UE ID_2) represented as “1.” As described herein, for example, the EES 464 may receive the private and public network address information of the UE 710 and optionally the first identifier of the UE 710 (e.g., “918369110173”) in the message 842.

As shown in FIG. 8B, the EAS 742 may transmit a message 846 including a service request. In some examples, the service request may invoke an API defined between the EAS 742 and the EES 744 (also referred to as an EDGE-3 API). The EAS 742 may include at least the public network address information of the UE 710 in the message 846.

At 848, the EES 744 may determine the private network address information of the UE 710 and/or an identifier of the UE 710 (e.g., UE ID_1 and/or UE ID_2 associated with the UE 710) based on the EEC identification table (e.g., the example EEC identification table shown in Table 2) to identify the EEC 712. For example, the EES 744 may match the public network address information of the UE 710 received in the message 846 to a public network address information entry in the EEC identification table. The EES 744 may then determine the private network address information corresponding to the matched public network address information of the UE 710 in the EEC identification table.

In one example, with reference to Table 2, if the public network address information of the UE 710 received in the message 846 is “190.1.1.1:1111”, the EES 744 may find “190.1.1.1:1111” in Table 2 and may determine that the private network address information of the UE 710 corresponding to “190.1.1.1:1111” is “192.168.1.1:1111.” In some examples, the EES 744 may optionally determine that the first identifier of the UE 710 (e.g., UE ID_1) corresponding to “190.1.1.1:1111” is “918369110173.” In some examples, the EES 744 may optionally determine that the second identifier of the UE 710 (e.g., UE ID_2) corresponding to “190.1.1.1:1111” is “1.”

At 850, the EES 744 may execute the service request from the EAS 742 based on the private network address information of the UE 710 (e.g., “192.168.1.1:1111”). For example, the EES 744 may use the private network address information of the UE 710 when invoking a network exposure function (NEF) application programming interface (API). In other examples, the EES 744 may execute the service request from the EAS 742 based on the first and/or second identifier of the UE (e.g., UE ID_2, UE ID_2). The EES 744 may transmit a message 852 to the EAS 742 in response to the service request in the message 846.

An example of a service request from the EAS 742 will now be described. In one example, the service request in the message 846 may be an EDGE-3 API for requesting the location of the UE 710 and the public network address information of the UE 710 included in the message 846 (e.g., “190.1.1.1:1111”) may serve as the key for the service request (e.g., the EDGE-3 API for requesting the location of the UE 710). In response to the service request, the EES 744 may determine the private network address information of the UE 710 from the EEC identification table (e.g., Table 2), and may execute a 3GPP network API for obtaining the location of the UE 710 using the private network address information of the UE 710 (e.g., “192.168.1.1:1111”) as the key for the 3GPP network API. The 3GPP network may return information indicating the location of the UE 710. The EES 744 may include the information indicating the location of the UE 710 in the response message 852.

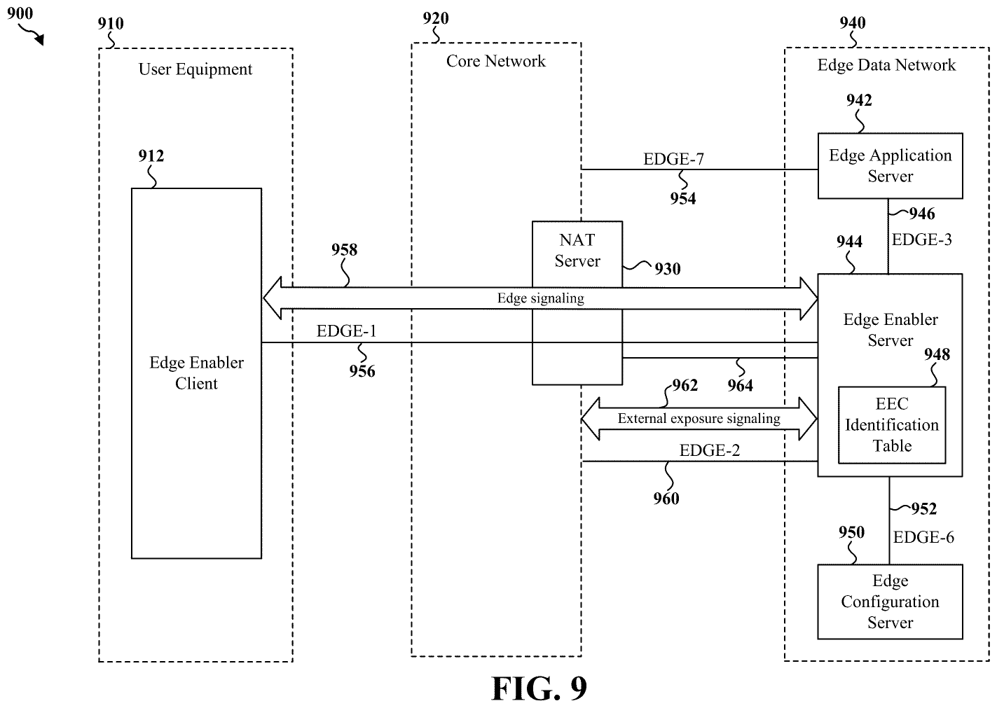

FIG. 9 is a diagram illustrating an example network architecture 900 including a user equipment (UE) 910, a core network 920, a NAT server 930, and an edge data network 940.

The UE 910 includes an edge enabler client (EEC) 912. The UE 910 may include additional components which have been omitted for ease of description, such as an applications processor, and a modem device in which the EEC 912 may reside.

The EEC 912 provides supporting functions needed for an application client in the UE 910. For example, the supporting functions may include retrieval and provisioning of configuration information to enable the exchange of application data traffic with the EAS 942, and discovery of EASs available in the edge data network 940. In some examples, the core network 920 may be a 3GPP core network.

The edge data network 940 may include an EAS 942, an EES 944, and an ECS 950. The EAS 942 may be an application server in the edge data network 940 configured to perform server functions. The EAS 942 may communicate with the core network 920 over the EDGE-7 reference point 954. An application client in the UE 710 may connect to the EAS 942 to access the features of edge computing. In some examples, the EAS 942 may interact with the core network 920 by directly invoking core network function APIs (e.g., if it is an entity trusted by the core network 920) and/or invoking core network capabilities through the EES 944.

The EES 944 provides supporting functions for the EAS 942 and the EEC 912. For example, the EES 944 may provision configuration information to the EEC 912 and may enable exchange of application data traffic with the EAS 942. The EES 944 may communicate with the EEC 912 via Edge signaling 958 over the EDGE-1 reference point 956. The EES 944 may communicate with the core network 920 via external exposure signaling 962 over the EDGE-2 reference point 960. The EES 944 may communicate with the NAT server 930 via an interface 964.

In some examples, the EES 944 supports the functionalities of an API invoker and an API exposing function. In some examples, the EES 944 supports external exposure of the core network 920 and service capabilities to the EAS 942 over an EDGE-3 reference point 946. In some examples, the EES 944 supports functions associated with registration, such as a registration procedure, a registration update, and/or a de-registration operation, for the EEC 912 and the EAS 942.

The ECS 950 provides supporting functions for the EEC 912 to connect with the EES 944. In some examples, the ECS 950 provisions Edge configuration information to the EEC 912. For example, the Edge configuration information may include information for the EEC 912 to connect to the EES 944 and/or the information for establishing a connection with the EES 944 (such as a Uniform Resource Identifier (URI)). In some examples, the ECS 950 supports functions associated with registration, such as a registration procedure, a registration update, and/or a de-registration operation, for the EES 944. The ECS 950 may communicate with the EES 944 via the EDGE-6 reference point 952.

The UE 910 may be assigned a private network address (e.g., a private Internet Protocol (IP) address and port number), which may be network address translated via the network address translation (NAT) server 930. The translated network address may serve as the public network address (e.g., a public Internet Protocol (IP) address and port number) of the UE 910. In some examples, the UE 910 may be aware of its private network address, but not its public network address. For example, entities in the UE 910, such as the EEC 912, may be aware of the private network address and may not be aware of the public network address.

In some examples, and as described in detail herein, the EES 944 may generate an EEC identification table that includes a mapping between at least the private and public network addresses of the UE 910. For example, as shown in the edge data network architecture 900, the EES 944 may generate the EEC identification table 948.

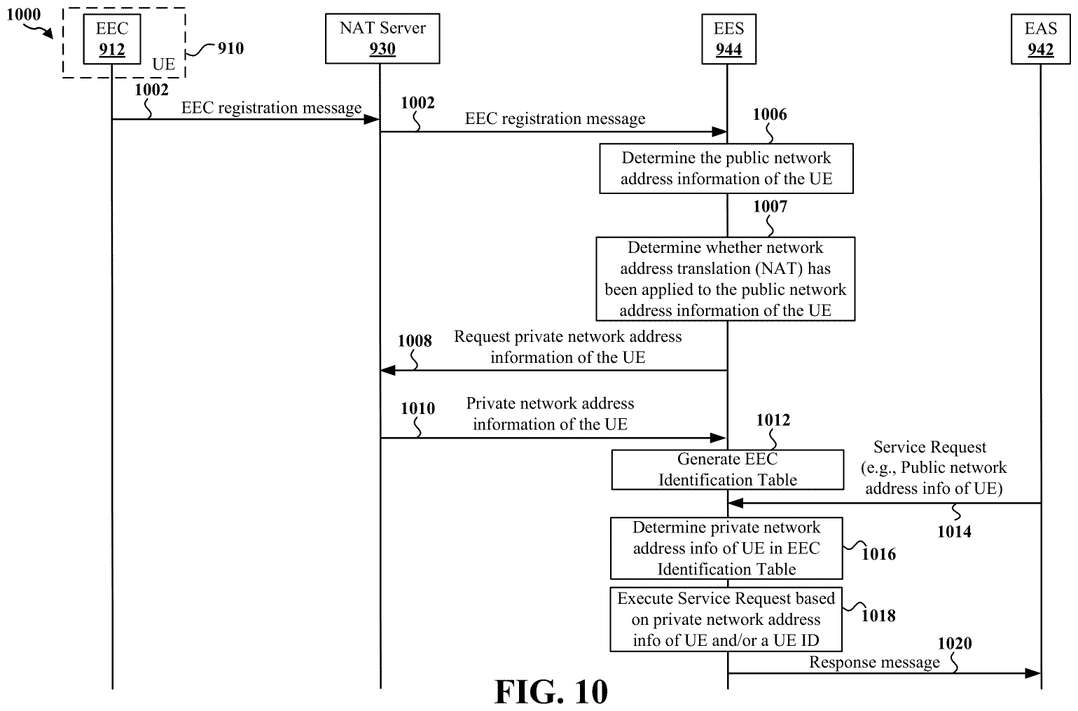

FIG. 10 illustrates a signal flow diagram 1000 in accordance with various aspects of the present disclosure. The signal flow diagram 1000 includes the UE 910, the NAT server 930, the EES 944, and the EAS 942. The UE 710 includes the EEC 912.

In some examples, the EEC 912 may perform a registration procedure with the EES 944. For example, during the registration procedure, the EEC 912 may transmit a registration message 1002 to the EES 944. In some examples, the registration message 1002 may include a first identifier of the UE 910 (also referred to as UE ID_1). In some examples, the first identifier of the UE 910 may be a GPSI of the UE 910. In some examples, the EEC 912 may include the private network address information associated with the UE 910 in the registration message 1002.

The registration message 1002 may be received by the NAT server 930. In some examples, the registration message 1002 may include one or more data packets (e.g., user plane (UP) data packets). The user plane (UP) protocol of the one or more data packets may include public network address information associated with the UE 910. For example, the user plane (UP) protocol of the one or more data packets may define a field (e.g., in the one or more data packets) configured to carry public network address information associated with the UE 910. In some examples, the public network address information associated with the UE 910 may be provided by the NAT server 930. The NAT server 930 may forward the registration message 1002 to the EES 944.

At 1006, the EES 944 determines the public network address information of the UE 910 from the registration message 1002. In some examples, the EES 944 derives the public network address information associated with the UE 910 (e.g., the public IP address and port number of the UE 910) from the UP protocol used for the registration message 1002.

At 1007, the EES 944 determines whether network address translation (NAT) has been applied to the public network address information of the UE 910 determined at 1006. As previously described, in some examples, the EEC 912 may include the private network address information associated with the UE 910 in the registration message 1002. In these examples, at 1007, the EES 944 can determine whether network address translation (NAT) has been applied to the public network address information determined at 1006 by comparing the public network address information determined at 1006 to the private network address information associated with the UE 910.

If the public network address information determined at 1006 does not match the private network address information associated with the UE 910, the EES 944 may transmit a message 1008 including a request (e.g., a query) for the private network address information of the UE 910 to the NAT server 930. In some examples, the request may be based on the public network address information of the UE 910 (e.g. the message 1008 may include the public network address information of the UE 910). For example, the EES 944 may transmit the message 1008 to determine the private network address information of the UE 910 that is associated with the public network address information of the UE 910 at the NAT server 930. The NAT server 930 may transmit a message 1010 including the private network address information associated with the UE 910 (e.g., the private IP address and port number of the UE 910).

It should be understood that if the public network address information determined at 1006 does not match the private network address information associated with the UE 910, the EES 944 may determine that network address translation (NAT) is applied. Moreover, if the public network address information determined at 1006 matches the private network address information associated with the UE 910, the EES 944 may determine that network address translation (NAT) is not applied. Therefore, if the public network address information determined at 1006 matches the private network address information associated with the UE 910, the EES 944 may not transmit the message 1008. This is because the EES 944 may determine that network address translation (NAT) is not applied and, therefore, a query to the NAT server 930 for the private network address information associated with the UE 910 may not be needed.

At 1012, the EES 944 generates an EEC identification table. In some examples, the EEC identification table may include one or more private network address information entries (e.g., a private Internet Protocol (IP) address and port number) and a mapping between each private network address information entry and a corresponding public network address information entry (e.g., a public Internet Protocol (IP) address and port number). In some examples, the EEC identification table may optionally include the first identifier of the UE 910 (also referred to as UE ID_1) and/or a second identifier of the UE 910 (also referred to as UE ID_2). In some examples, the second identifier of the UE 910 may be an Edge UE ID assigned by the EES 944. The first identifier of the UE 910 and/or the second identifier of the UE 910 may be mapped to a private network address information entry in the EEC identification table. An example EEC identification table generated at 1012 is shown in Table 3.

TABLE 3

| UE private | UE public | UE ID_1 | UE ID_2 |
|---|---|---|---|
| network address info | network address info | (optional) | (optional) |
| 192.168.1.5:1111 | 190.1.1.5:1111 | 718369249615 | 5 |
| 192.168.1.6:1113 | 190.1.1.6:1114 | 123@berlin.de | 6 |
| 192.168.1.7:1811 | 190.1.1.7:1811 | 456@seoul.kr | 7 |
| 192.168.1.8:1711 | 190.1.1.8:1711 | 789@sandiego.us | 8 |

In Table 3, each row indicates a mapping between private network address information of a UE and the corresponding public network address information of the UE. As shown in Table 3, a first optional identifier of the UE (e.g., UE ID_1) and a second optional identifier of the UE (e.g., UE ID_2) may be mapped to the private network address information of that UE.

In one example scenario, with reference to Table 3 and FIG. 10, the private network address information of the UE 910 may include a private Internet Protocol (IP) address and port number represented as “192.168.1.5:1111”, a public Internet Protocol (IP) address and port number represented as “190.1.1.5:1111”, a first identifier of the UE 910 (e.g., UE ID_1) represented as “718369249615”, and a second identifier of the UE 910 (e.g., UE ID_2) represented as “5.”

As shown in FIG. 10, the EAS 942 may transmit a message 1014 including a service request. In some examples, the service request may invoke an API defined between the EAS 942 and the EES 944 (also referred to as an EDGE-3 API). The EAS 942 may include at least the public network address information of the UE 910 in the message 1014.

At 1016, the EES 944 may determine the private network address information of the UE 910 and/or the identifier of the UE 910 based on the EEC identification table (e.g., the example, EEC identification table shown in Table 3). For example, the EES 944 may match the public network address information of the UE 910 received in the message 1014 to a public network address information entry in the EEC identification table. The EES 944 may then determine the private network address information corresponding to the matched public network address information of the UE 910 in the EEC identification table.

In one example, with reference to Table 3, if the public network address information of the UE 910 received in the message 1014 is “190.1.1.5:1111”, the EES 944 may find “190.1.1.5:1111” in Table 3 and may determine that the private network address information of the UE 910 corresponding to “190.1.1.5:1111” is “192.168.1.5:1111.” In some examples, the EES 944 may optionally determine that the first identifier of the UE 910 (e.g., UE ID_1) corresponding to “190.1.1.5:1111” is “718369249615.” In some examples, the EES 744 may optionally determine that the second identifier of the UE 910 (e.g., UE ID_2) corresponding to “190.1.1.5:1111” is “5.”

At 1018, the EES 944 may execute the service request from the EAS 942 based on the private network address information of the UE 910 (e.g., “192.168.1.5:1111”). In other examples, the EES 944 may execute the service request from the EAS 942 based on the first and/or second identifier of the UE 910 (e.g., UE ID_2, UE ID_2). The EES 944 may transmit a message 1020 to the EAS 942 in response to the service request in the message 1014.

An example of a service request from the EAS 942 will now be described. In one example, the service request in the message 1014 may be an EDGE-3 API for requesting the location of the UE 910 and the public network address information of the UE 910 included in the message 1014 (e.g., “190.1.1.5:1111”) may serve as the key for the service request (e.g., the EDGE-3 API for requesting the location of the UE 910). In response to the service request, the EES 944 may determine the private network address information of the UE 910 from the EEC identification table (e.g., Table 3), and may execute a 3GPP network API for obtaining the location of the UE 910 using the private network address information of the UE 710 (e.g., “190.1.1.5:1111”) as the key for the 3GPP network API. The 3GPP network may return information indicating the location of the UE 910. The EES 944 may include the information indicating the location of the UE 910 in the response message 1020.

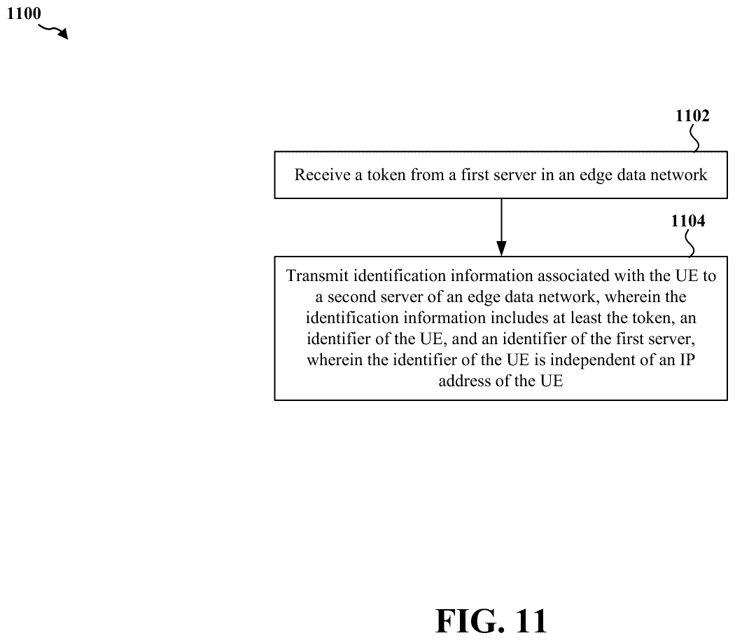

FIG. 11 is a flowchart 1102 of a method of wireless communication. The method may be performed by a UE (e.g., the UE 410; the apparatus 1302/1302′; the processing system 1414, which may include the memory 360 and which may be the entire UE 410 or a component of the UE 410, such as the TX processor 368, the RX processor 356, and/or the controller/processor 359).

At 1102, the UE receives a token from a first server in an edge data network. In some examples, with reference to FIG. 6, the EEC 422 in the UE 410 receives the token in message 606 from the EAS 462.

At 1104, the UE transmits identification information associated with the UE to a second server (e.g., the EES 464) of an edge data network, wherein the identification information includes at least the token, an identifier of the UE (e.g., GPSI), and an identifier of the first server (e.g., EAS ID), wherein the identifier of the UE is independent of an Internet Protocol (IP) address of the UE. In some examples, with reference to FIG. 6, the EEC 422 may transmit a message 612 including the token, an identifier of the UE 410 (also referred to as a UE Identifier and UE ID), and the identifier of the EAS 462.

In some examples, the identifier of the UE is a generic public subscription identifier (GPSI). In some examples, the first server is an edge application server (EAS) and the second server is an edge enabler server (EES). In some examples, the identification information is associated with an identifier of an edge enabler client (EEC) in the UE.

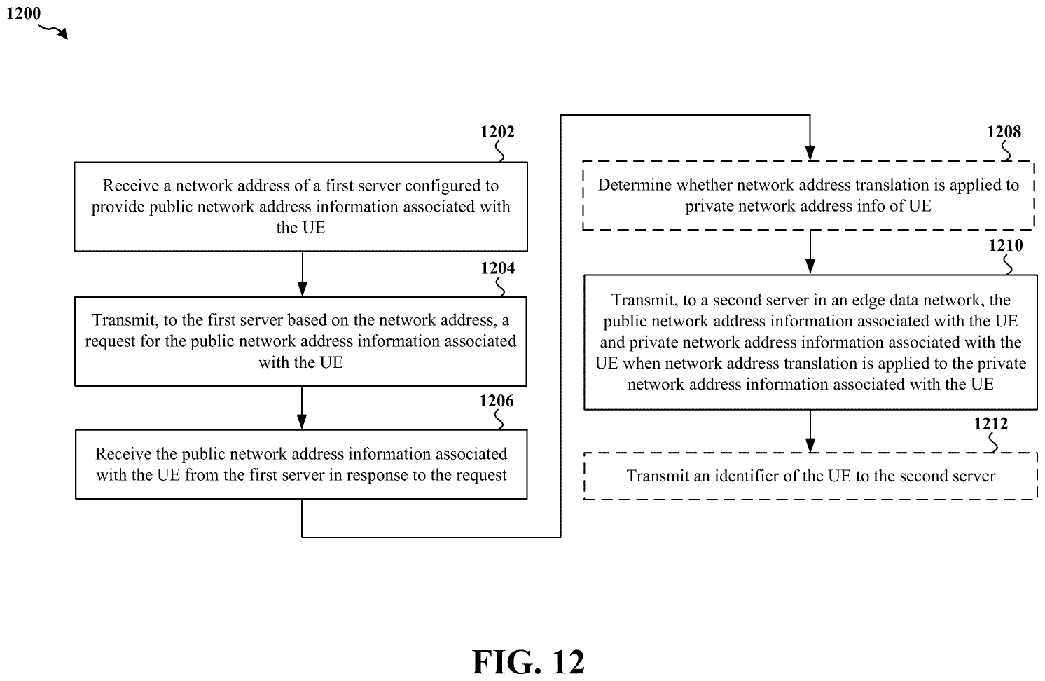

FIG. 12 is a flowchart 1202 of a method of wireless communication. The method may be performed by a UE (e.g., the UE 710; the apparatus 1302/1302′; the processing system 1414, which may include the memory 360 and which may be the entire UE 710 or a component of the UE 410, such as the TX processor 368, the RX processor 356, and/or the controller/processor 359). In FIG. 12, operations represented with dashed lines represent optional operations.

At 1202, the UE receives a network address of a first server configured to provide public network address information associated with the UE. In some examples, the UE may receive the network address of the first server from an entity in a core network (e.g., AMF and/or SMF) via a parameter in a protocol configuration options (PCO) information element (IE). For example, with reference to FIG. 8A, the UE 710 may receive the network address (e.g., via the messages 812, 814) of the first server (e.g., the STUN server 730) from an entity in a core network 720 (e.g., AMF and/or SMF). In some examples, the UE may receive the network address of the first server from an edge configuration server (e.g., the ECS 750 in FIG. 8A) in an edge data network. In some examples, the UE may receive the network address of the first server from an edge enabler server (e.g., via the message 834 from the EES 744 in FIG. 8A) in the edge data network. In some examples, the first server is a Session Traversal Utilities for NAT (STUN) server.

At 1204, the UE transmits, to the first server based on the network address, a request for the public network address information associated with the UE. For example, with reference to FIG. 8A, the EEC 712 of the UE 710 may transmit a message 836 including the private network address information associated with the UE 710 to the STUN server 730.

At 1206, the UE receives the public network address information associated with the UE from the first server in response to the request. For example, the STUN server 730 may transmit a message 838 to the EEC 712 of the UE 710 using the private network address information associated with the UE 710, where the message 838 includes the public network address information associated with the UE 710.

At 1208, the UE determines whether network address translation is applied to the private network address information associated with the UE. In some examples, the EEC 712 may compare the private network address information associated with the UE 710 to the public network address information in the message 838. If the private network address information associated with the UE 710 matches the public network address information in the message 838, the EEC 712 may determine that no network address translation (NAT) is applied. If the private network address information associated with the UE 710 does not match the public network address information in the message 838, the EEC 712 may determine that network address translation (NAT) is applied.

At 1210, the UE transmits, to a second server in an edge data network, the public network address information associated with the UE and private network address information associated with the UE when network address translation is applied to the private network address information associated with the UE. In some examples, the second server is an edge enabler server (EES).

At 1212, the UE transmits an identifier of the UE to the second server. In some examples, the identifier of the UE is a generic public subscription identifier (GPSI).

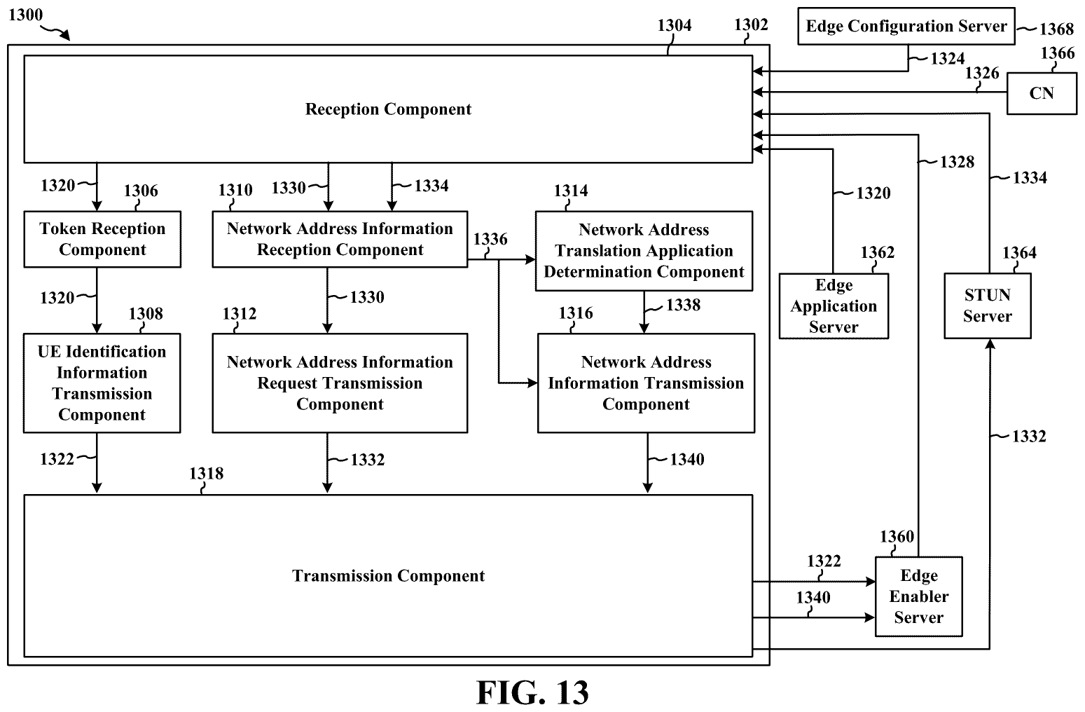

FIG. 13 is a conceptual data flow diagram 1300 illustrating the data flow between different means/components in an example apparatus 1302. The apparatus may be a UE. The apparatus includes a reception component 1304 that receives communications from network entities (e.g., the edge enabler server 1360, the edge application server 1362, the STUN server 1364, the edge configuration server 1368, the core network 1366). The apparatus further includes a token reception component 1306 that receives a token 1320 from a server 1362 (e.g., edge application server) in an edge data network. The apparatus further includes a UE identification information transmission component 1308 that transmits identification information 1322 associated with the UE to a server 1360 of an edge data network, wherein the identification information includes at least the token 1320, an identifier of the UE, and an identifier of the server 1362, wherein the identifier of the UE is independent of an IP address of the UE, and transmits an identifier of the UE to the second server.

The apparatus further includes a network address information reception component 1310 that receives a network address 1330 of a server 1364 (e.g., STUN server) configured to provide public network address information associated with the UE. The network address information reception component 1310 further receives public network address information 1334 associated with the UE from the server 1364 via the signal 1334.

The network address 1330 may be received from the edge configuration server 1368 via signal 1324, the core network (CN) 1366 via the signal 1326, and/or the edge enabler server 1360 via the signal 1328. The apparatus further includes a network address information request transmission component 1312 that transmits, to the server 1364 based on the network address 1330, a request 1332 for the public network address information associated with the UE. The apparatus further includes a network address translation application determination component 1314 that determines whether network address translation is applied to private network address information of the UE. The signal 1336 may include public network address information of the UE, and the signal 1338 may include an indication of whether or not network address translation is applied.

The apparatus further includes a network address information transmission component 1316 that transmits, to a server 1360 in an edge data network, a message 1340 including the public network address information associated with the UE and private network address information associated with the UE when network address translation is applied to the private network address information associated with the UE.

The apparatus further includes a transmission component 1318 that transmits communications to network entities (e.g., the edge enabler server 1360, the STUN server 1364.

The apparatus may include additional components that perform each of the blocks of the algorithm in the aforementioned flowcharts of FIGS. 11 and 12. As such, each block in the aforementioned flowcharts of FIGS. 11 and 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

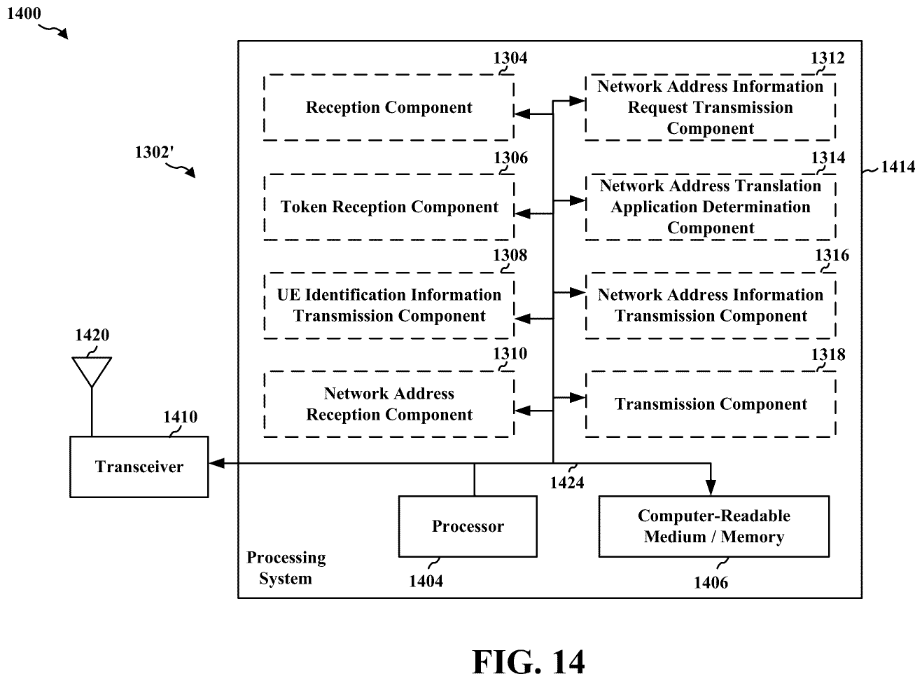

FIG. 14 is a diagram 1400 illustrating an example of a hardware implementation for an apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware components, represented by the processor 1404, the components 1304, 1306, 1308, 1310, 1312, 1314, 1316, 1318 and the computer-readable medium/memory 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The transceiver 1410 receives a signal from the one or more antennas 1420, extracts information from the received signal, and provides the extracted information to the processing system 1414, specifically the reception component 1304. In addition, the transceiver 1410 receives information from the processing system 1414, specifically the transmission component 1318, and based on the received information, generates a signal to be applied to the one or more antennas 1420. The processing system 1414 includes a processor 1404 coupled to a computer-readable medium/memory 1406. The processor 1404 is responsible for general processing, including the execution of software stored on the computer-readable medium/memory 1406. The software, when executed by the processor 1404, causes the processing system 1414 to perform the various functions described supra for any particular apparatus. The computer-readable medium/memory 1406 may also be used for storing data that is manipulated by the processor 1404 when executing software. The processing system 1414 further includes at least one of the components 1304, 1306, 1308, 1310, 1312, 1314, 1316, 1318. The components may be software components running in the processor 1404, resident/stored in the computer readable medium/memory 1406, one or more hardware components coupled to the processor 1404, or some combination thereof. The processing system 1414 may be a component of the UE 350 and may include the memory 360 and/or at least one of the TX processor 368, the RX processor 356, and the controller/processor 359. Alternatively, the processing system 1414 may be the entire UE (e.g., sec 350 of FIG. 3).

In one configuration, the apparatus 1302/1302′ for wireless communication includes means for receiving a token from a first server in an edge data network, means for transmitting identification information associated with the apparatus to a second server of the edge data network, wherein the identification information includes at least the token, an identifier of the apparatus, and an identifier of the first server, wherein the identifier of the apparatus is independent of an Internet Protocol (IP) address of the apparatus, means for receiving a network address of a first server configured to provide public network address information associated with the apparatus, means for transmitting, to the first server based on the network address, a request for the public network address information associated with the apparatus, means for receiving the public network address information associated with the apparatus from the first server in response to the request, means for transmitting, to a second server in an edge data network, the public network address information associated with the apparatus and private network address information associated with the apparatus when network address translation is applied to the private network address information associated with the apparatus, means for transmitting an identifier of the apparatus to the second server, means for determining whether network address translation is applied to the private network address information associated with the UE.

The aforementioned means may be one or more of the aforementioned components of the apparatus 1302 and/or the processing system 1414 of the apparatus 1302′ configured to perform the functions recited by the aforementioned means. As described supra, the processing system 1414 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

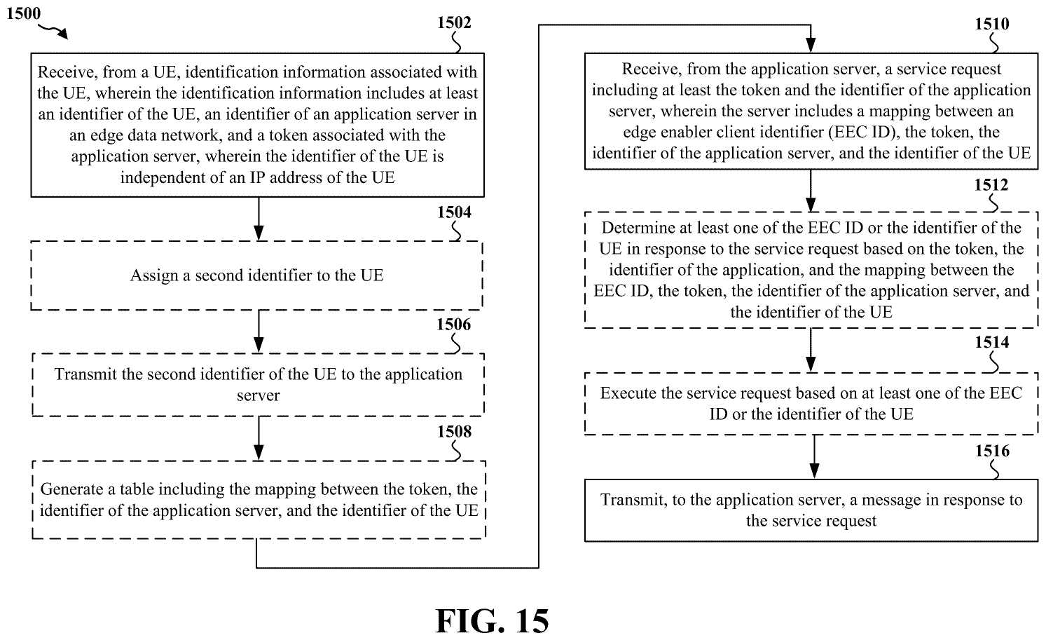

FIG. 15 is a flowchart 1500 of a method of wireless communication. The method may be performed by a server in an edge data network (e.g., the EES 464; the apparatus 1802/1802′; the processing system 1914).

At 1502, the server (e.g., the EES 464) receives, from a user equipment (UE), identification information associated with the UE, wherein the identification information includes at least an identifier of the UE, an identifier of an application server (e.g., EAS) in an edge data network, and a token associated with the application server, wherein the identifier of the UE is independent of an Internet Protocol (IP) address of the UE. For example, the EES 464 may receive the message 612 including the token, an identifier of the UE 410 (also referred to as a UE Identifier and UE ID), and the identifier of the EAS 462.

At 1504 the server assigns a second identifier to the UE and, at 1506, the server transmits the second identifier of the UE to the application server. For example, at 614, the EES 464 may assign an optional identifier to the UE 410 (also referred to herein as an optional UE identifier, optional UE ID, and Edge UE ID). The EES 464 may then transmit the message 616 including the optional identifier of the UE 410 to the EAS 462.

At 1508, the server generates a table including the mapping between the token, the identifier of the application server, and the identifier of the UE. For example, at 618, the EES 464 generates an EEC identification table (e.g., the EEC identification table 510 in FIG. 5). In some examples, the EEC identification table may include one or more EEC IDs and a mapping between each EEC ID and a corresponding token, identifier of an EAS, and/or an identifier of a UE. In some aspects of the disclosure, an optional identifier of a UE may be mapped to an EEC ID in the EEC identification table. In some examples, different tokens or different UE IDs (EEC ID, Edge UE ID) can address the same UE. An example EEC identification table generated at 618 is shown in Table 1.

At 1510, the server receives, from the application server, a service request (e.g., EDGE-3 API) including at least the token and the identifier of the application server, wherein the server includes a mapping between an edge enabler client identifier (EEC ID), the token, the identifier of the application server, and the identifier of the UE. For example, the service request may be included in the message 620 from the EAS 462.

At 1512, the server determines at least one of the EEC ID or the identifier of the UE in response to the service request based on the token, the identifier of the application server, and the mapping between the EEC ID, the token, the identifier of the application server, and the identifier of the UE. For example, the EES 464 may match the token and the identifier of the EAS 462 (EAS ID) received in the message 620 to a token and an identifier of an EAS (EAS ID) in the EEC identification table (e.g., Table 1). In one example, with reference to Table 1, if the token and the identifier of the EAS 462 (EAS ID) received in the message 620 are “OACR1” and EAS ID1″, respectively, the EES 464 may find “OACR1” and “EAS ID1” in Table 1 and may determine that the EEC ID corresponding to “OACR1” and “EAS ID1” is “EEC ID1.”

At 1514, the server executes the service request based on at least one of the EEC ID or the identifier of the UE. In some examples, the server may execute the service request by invoking a network exposure function (NEF) application programming interface (API) based on the private network address information associated with the UE.

At 1516, the server transmits, to the application server in the edge data network, a message in response to the service request. In some aspects, and as described herein, the server transmits the message (e.g., the response message 626) in response to the service request based on at least the mapping.

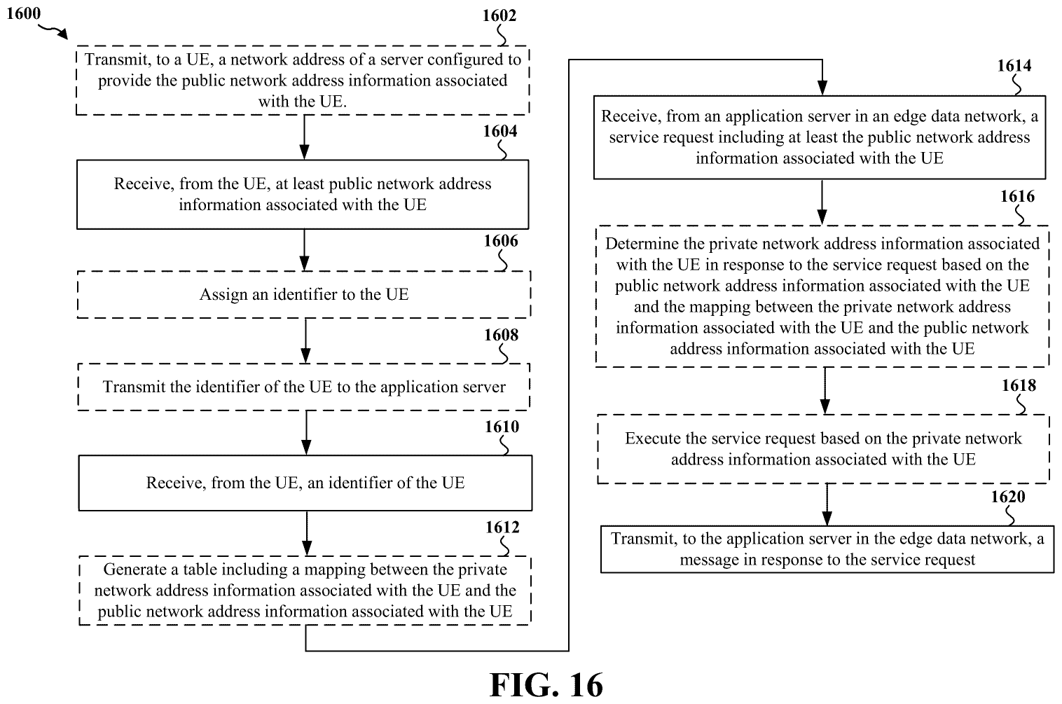

FIG. 16 is a flowchart 1600 of a method of wireless communication. The method may be performed by a server in an edge data network (e.g., the EES 744; the apparatus 1802/1802′; the processing system 1914).

At 1602, the server transmits, to a UE, a network address of a server (e.g., the STUN server 730 in FIG. 8A) configured to provide the public network address information associated with the UE.

At 1604, the server receives, from a user equipment (UE), at least public network address information associated with the UE. In some aspects, the server further receives private network address information associated with the UE. In some examples, the public network address information associated with the UE includes a first Internet Protocol (IP) address and a first port number, and the private network address information associated with the UE includes a second IP address and a second port number. In some examples, the EES 744 may receive the message 842 including both the private network address information associated with the UE 710 and the public network address information associated with the UE 710.

At 1606, the server assigns an identifier (e.g., Edge UE ID) to the UE and, at 1608, the server transmits the identifier of the UE to the application server (e.g., EAS).

At 1610, the server receives, from the UE, an identifier of the UE. In some examples, the identifier of the UE is a generic public subscription identifier (GPSI). At 1612, the server generates a table including a mapping between the private network address information associated with the UE and the public network address information associated with the UE. An example of the generated table is described with reference to Table 2. In some examples, the mapping between the private network address information associated with the UE and the public network address information associated with the UE maps the identifier of the UE (e.g., the assigned identifier, such as the Edge UE ID, and/or the received identifier, such as the GPSI) to the private network address information associated with the UE and the public network address information associated with the UE.

At 1614, the server receives, from an application server (e.g., EAS) in an edge data network, a service request (e.g., EDGE-3 API) including at least the public network address information associated with the UE. For example, with reference to FIG. 8B, the service request may be included in the message 846. The server includes the mapping between the private network address information associated with the UE and the public network address information associated with the UE. For example, the EES 744 may include and/or may have access to an EEC Identification Table as described with reference to Table 2.

At 1616, the server determines the private network address information associated with the UE in response to the service request based on the public network address information associated with the UE and the mapping between the private network address information associated with the UE and the public network address information associated with the UE. For example, the EES 744 may match the public network address information of the UE 710 received in the message 846 to a public network address information entry in the EEC identification table. The EES 744 may then determine the private network address information corresponding to the matched public network address information of the UE 710 in the EEC identification table.

At 1618, the server executes the service request based on the private network address information associated with the UE. In some examples, the server executes the service request by invoking a network exposure function (NEF) application programming interface (API) based on the private network address information associated with the UE.

At 1620, the server transmits, to the application server in the edge data network, a message in response to the service request. In some aspects, and as described herein, the server transmits the message (e.g., the response message 852) in response to the service request based on at least the mapping. For example, the EES 744 may include information returned from an API (e.g., a location of the UE 710 in the response message 852) in a response message for the EAS 742.

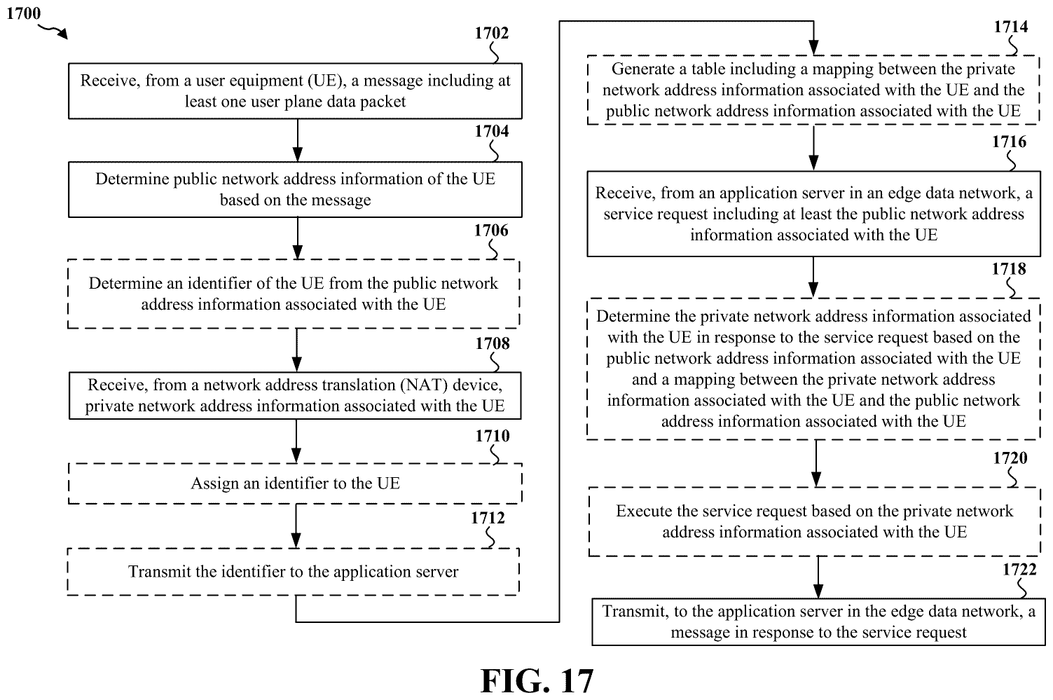

FIG. 17 is a flowchart 1700 of a method of wireless communication. The method may be performed by a server in an edge data network (e.g., the EES 944; the apparatus 1802/1802′; the processing system 1914).

At 1702, the server (e.g., EES 944) receives, from a UE (e.g., UE 910), a message including at least one user plane data packet. For example, during the registration procedure, the EEC 912 may transmit a registration message 1002 to the EES 944. In some examples, the registration message 1002 may include one or more data packets (e.g., user plane (UP) data packets). The user plane (UP) protocol of the one or more data packets may include public network address information associated with the UE 910.

At 1704, the server determines public network address information of the UE based on the message. In some examples, the EES 944 derives the public network address information associated with the UE 910 (e.g., the public IP address and port number of the UE 910) from the UP protocol used for the registration message 1002.

At 1706, the server determines an identifier of the UE from the public network address information associated with the UE. In some examples, the identifier of the UE is a generic public subscription identifier (GPSI).

At 1708, the server receives, from a network address translation (NAT) device, private network address information associated with the UE. For example, the NAT server 930 may transmit a message 1010 to the server (e.g., EES 944) including the private network address information associated with the UE 910 (e.g., the private IP address and port number of the UE 910).

At 1710, the server assigns an identifier (e.g., an Edge UE ID) to the UE and, at 1712, the server transmits the identifier to the application server.

At 1714, the server generates a table including a mapping between the private network address information associated with the UE and the public network address information associated with the UE. In some examples, the mapping between the private network address information associated with the UE and the public network address information associated with the UE maps the identifier of the UE (e.g., the assigned identifier, such as the Edge UE ID, and/or the received identifier, such as the GPSI) to the private network address information associated with the UE and the public network address information associated with the UE.

For example, with reference to FIG. 10, at 1012, the EES 944 generates an EEC identification table. In some examples, the EEC identification table may include one or more private network address information entries (e.g., a private Internet Protocol (IP) address and port number) and a mapping between each private network address information entry and a corresponding public network address information entry (e.g., a public Internet Protocol (IP) address and port number). In some examples, the EEC identification table may optionally include the first identifier of the UE 910 (also referred to as UE ID_1) and/or a second identifier of the UE 910 (also referred to as UE ID_2). In some examples, the second identifier of the UE 910 may be an Edge UE ID assigned by the EES 944. The first identifier of the UE 910 and/or the second identifier of the UE 910 may be mapped to a private network address information entry in the EEC identification table. An example EEC identification table generated at 1012 is shown in Table 3.

At 1716, the server receives, from an application server (e.g., EAS) in an edge data network, a service request (e.g., EDGE-3 API) including at least the public network address information associated with the UE. The server includes the mapping between the private network address information associated with the UE and the public network address information associated with the UE

At 1718, the server determines the private network address information associated with the UE in response to the service request based on the public network address information associated with the UE and the mapping between the private network address information associated with the UE and the public network address information associated with the UE.

For example, with reference to FIG. 10, at 1016, the EES 944 may determine the private network address information of the UE 910 and/or the identifier of the UE 910 based on the EEC identification table (e.g., the example, EEC identification table shown in Table 3). For example, the EES 944 may match the public network address information of the UE 910 received in the message 1014 to a public network address information entry in the EEC identification table. The EES 944 may then determine the private network address information corresponding to the matched public network address information of the UE 910 in the EEC identification table.

At 1720, the server executes the service request based on the private network address information associated with the UE. In some examples, the server executes the service request by invoking a network exposure function (NEF) application programming interface (API) based on the private network address information associated with the UE.

At 1722, the server transmits, to the application server in the edge data network, a message in response to the service request. In some aspects, and as described herein, the server transmits the message (e.g., the response message 1020) in response to the service request based on at least the mapping. For example, the EES 944 may include information returned from an API (e.g., a location of the UE 910 in the response message 1020) in a response message for the EAS 942.

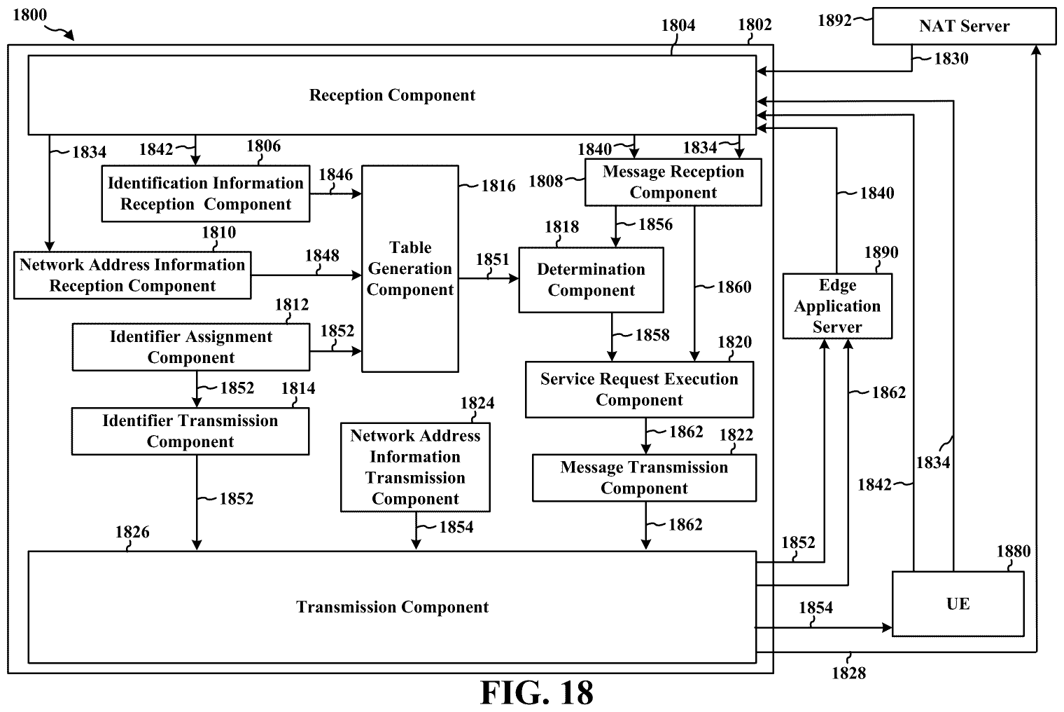

FIG. 18 is a conceptual data flow diagram 1800 illustrating the data flow between different means/components in an example apparatus 1802. The apparatus may be a server device (e.g., an edge enabler server in an edge data network).

The apparatus includes a reception component 1804 that receives communications from network entities (e.g., the UE 1880, the edge application server 1890, the NAT server 1892).

The apparatus further includes identification information reception component 1806 that receives, from a UE (e.g., UE 1880), identification information 1842 associated with the UE, wherein the identification information includes at least an identifier of the UE, an identifier of an application server in an edge data network, and a token associated with the application server, wherein the identifier of the UE is independent of an IP address of the UE, and receives, from the UE, an identifier of the UE.

The apparatus further includes a message reception component 1808 that receives a message (e.g., message 1840), from the application server (e.g., edge application server 1890), including a service request including at least the token and the identifier of the application server, wherein the server includes a mapping between an edge enabler client identifier (EEC ID), the token, the identifier of the application server, and the identifier of the UE. In some examples, the service request includes at least the public network address information associated with the UE. The message reception component 1808 further receives, from the UE, a message 1834 including at least one user plane data packet.

The apparatus further includes a network address information reception component 1810 that receives (e.g., via the message 1834) from the UE, public network address information and private network address information associated with the UE, and receives, from a network address translation (NAT) device (e.g., NAT server 1892), private network address information 1830 associated with the UE (e.g., in response to a query in the signal 1828).

The apparatus further includes an identifier assignment component 1812 that assigns a second identifier 1852 to the UE. The apparatus further includes an identifier transmission component 1814 that transmits the second identifier 1852 of the UE to the application server (e.g., edge application server 1890).

The apparatus further includes a table generation component 1816 that generates a table including the mapping between the token, the identifier of the application server, and the identifier of the UE. The token, the identifier of the application server, and the identifier of the UE may be included in signal 1846. The table generation component 1816 further generates a table including a mapping between the private network address information associated with the UE and the public network address information associated with the UE. The public and private network address information associated with the UE may be included in signal 1848. The generated table may be included in the signal 1851.

The apparatus further includes a determination component 1818 that determines at least one of the EEC ID or the identifier of the UE in response to the service request included in the input signal 1856 based on the token, the identifier of the application server, and the mapping (e.g., the mapping in the generated table in the signal 1851) between the EEC ID, the token, the identifier of the application server, and the identifier of the UE, and determines the private network address information associated with the UE in response to the service request based on the public network address information associated with the UE and the mapping (e.g., the mapping in the generated table in the signal 1851) between the private network address information associated with the UE and the public network address information associated with the UE. The determination component 1818 further determines public network address information of the UE based on the message 1834. The determination component 1818 further determines an identifier of the UE from the public network address information associated with the UE.

The apparatus further includes a service request execution component 1820 that executes the service request (e.g., a service request in signal 1860) based on at least one of the EEC ID or the identifier of the UE, and executes the service request based on the private network address information associated with the UE (e.g., the private network address information associated with the UE in the signal 1858).

The apparatus further includes a message transmission component 1822 that transmits, to the application server, a message 1862 in response to the service request.

The apparatus further includes a network address information transmission component 1824 that transmits, to a UE (e.g., UE 1880), a network address 1854 of a server configured to provide the public network address information associated with the UE.

The apparatus further includes a transmission component 1826 that transmits communications to network entities (e.g., the UE 1880, the edge application server 1890, the NAT server 1892).

The apparatus may include additional components that perform each of the blocks of the algorithm in the aforementioned flowcharts of FIGS. 15-17. As such, each block in the aforementioned flowcharts of FIGS. 15-17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

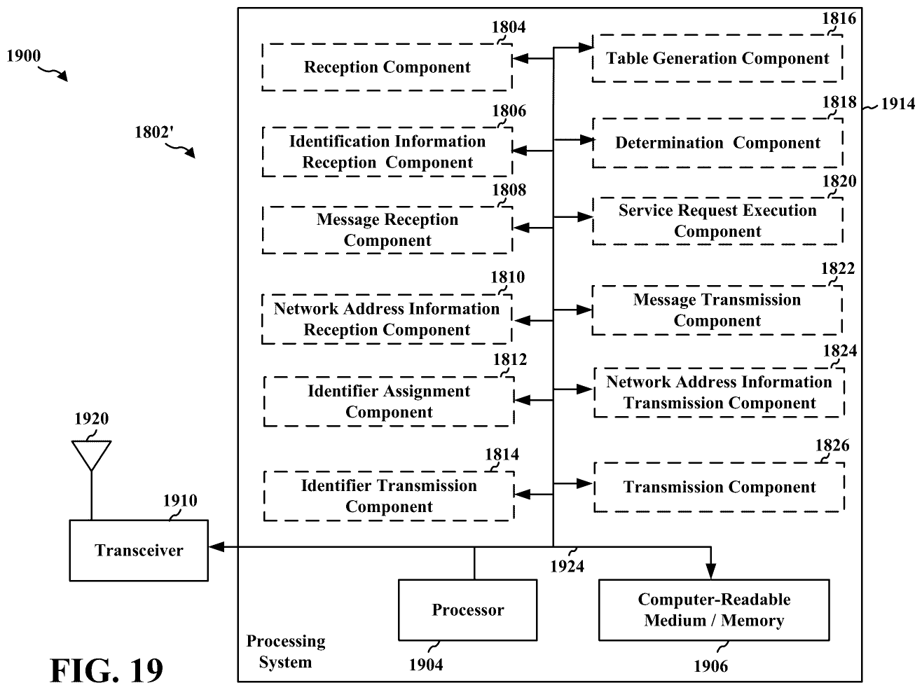

FIG. 19 is a diagram 1900 illustrating an example of a hardware implementation for an apparatus 1802′ employing a processing system 1914. The processing system 1914 may be implemented with a bus architecture, represented generally by the bus 1924. The bus 1924 may include any number of interconnecting buses and bridges depending on the specific application of the processing system 1914 and the overall design constraints. The bus 1924 links together various circuits including one or more processors and/or hardware components, represented by the processor 1904, the components 1804, 1806, 1808, 1810, 1812, 1814, 1816, 1818, 1820, 1822, 1824, 1826, and the computer-readable medium/memory 1906. The bus 1924 may also link various other circuits such as timing sources, peripherals, voltage regulators, and power management circuits, which are well known in the art, and therefore, will not be described any further.

The processing system 1914 may be coupled to a transceiver 1910. The transceiver 1910 is coupled to one or more antennas 1920. The transceiver 1910 provides a means for communicating with various other apparatus over a transmission medium. The transceiver 1910 receives a signal from the one or more antennas 1920, extracts information from the received signal, and provides the extracted information to the processing system 1914, specifically the reception component 1804. In addition, the transceiver 1910 receives information from the processing system 1914, specifically the transmission component 1826, and based on the received information, generates a signal to be applied to the one or more antennas 1920. The processing system 1914 includes a processor 1904 coupled to a computer-readable medium/memory 1906. The processor 1904 is responsible for general processing, including the execution of software stored on the computer-readable medium/memory 1906. The software, when executed by the processor 1904, causes the processing system 1914 to perform the various functions described supra for any particular apparatus. The computer-readable medium/memory 1906 may also be used for storing data that is manipulated by the processor 1904 when executing software. The processing system 1914 further includes at least one of the components 1804, 1806, 1808, 1810, 1812, 1814, 1816, 1818, 1820, 1822, 1824, 1826. The components may be software components running in the processor 1904, resident/stored in the computer readable medium/memory 1906, one or more hardware components coupled to the processor 1904, or some combination thereof.

In one configuration, the apparatus 1802/1802′ for wireless communication includes means for receiving, from a user equipment (UE), identification information associated with the UE, wherein the identification information includes at least, an identifier of the UE, an identifier of an application server in an edge data network, and a token associated with the application server, wherein the identifier of the UE is independent of an Internet Protocol (IP) address of the UE, means for receiving, from the application server, a service request including at least the token and the identifier of the application server, wherein the apparatus includes a mapping between an edge enabler client identifier (EEC ID), the token, the identifier of the application server, and the identifier of the UE, means for transmitting, to the application server, a message in response to the service request, means for determining at least one of the EEC ID or the identifier of the UE in response to the service request based on the token, the identifier of the application server, and the mapping between the EEC ID, the token, the identifier of the application server, and the identifier of the UE, means for executing the service request based on at least one of the EEC ID or the identifier of the UE, means for generating a table including the mapping between the token, the identifier of the application server, and the identifier of the UE, means for assigning a second identifier to the UE, means for transmitting the second identifier of the UE to the application server, means for receiving, from a user equipment (UE), public network address information and private network address information associated with the UE, means for receiving, from an application server in an edge data network, a service request including at least the public network address information associated with the UE, wherein the apparatus includes a mapping between the private network address information associated with the UE and the public network address information associated with the UE, means for transmitting, to the application server in the edge data network, a message in response to the service request, means for determining the private network address information associated with the UE in response to the service request based on the public network address information associated with the UE and the mapping between the private network address information associated with the UE and the public network address information associated with the UE, means for executing the service request based on the private network address information associated with the UE, means for invoking a network exposure function (NEF) application programming interface (API) based on the private network address information associated with the UE, means for transmitting, to the UE, a network address of a server configured to provide the public network address information associated with the UE, means for receiving, from the UE, an identifier of the UE, wherein the mapping between the private network address information associated with the UE and the public network address information associated with the UE maps the identifier of the UE to the private network address information associated with the UE and the public network address information associated with the UE, means for receiving, from a user equipment (UE), a message including at least one user plane data packet, means for determining public network address information of the UE based on the message, means for receiving, from a network address translation (NAT) device, private network address information associated with the UE, means for receiving, from an application server in an edge data network, a service request including at least the public network address information associated with the UE, wherein the apparatus includes a mapping between the private network address information associated with the UE and the public network address information associated with the UE, means for transmitting, to the application server in the edge data network, a message in response to the service request, means for determining an identifier of the UE from the public network address information associated with the UE, wherein the mapping between the private network address information associated with the UE and the public network address information associated with the UE maps the identifier of the UE to the private network address information associated with the UE and the public network address information associated with the UE.

The aforementioned means may be one or more of the aforementioned components of the apparatus 1802 and/or the processing system 1914 of the apparatus 1802′ configured to perform the functions recited by the aforementioned means. As described supra, the processing system 1914 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The following provides an overview of aspects of the present disclosure:

Aspect 1: A method of wireless communication, comprising: receiving a token from a first server in an edge data network; and transmitting identification information associated with a user equipment (UE) to a second server of the edge data network, wherein the identification information includes at least the token, an identifier of the UE, and an identifier of the first server, wherein the identifier of the UE is independent of an Internet Protocol (IP) address of the UE.

Aspect 2: The method of aspect 1, wherein the identifier of the UE is a generic public subscription identifier (GPSI).

Aspect 3: The method of aspect 1 or 2, wherein the first server is an edge application server (EAS) and the second server is an edge enabler server (EES).

Aspect 4: The method of any of aspects 1 through 3, wherein the identification information is associated with an identifier of an edge enabler client (EEC) in the UE.

Aspect 5: An apparatus for wireless communication, comprising: a memory; and at least one processor coupled to the memory and configured to perform a method of any one of aspects 1 through 4.

Aspect 6: An apparatus for wireless communication comprising at least one means for performing a method of any one of aspects 1 through 4.

Aspect 7: A computer-readable medium storing computer executable code, the code when executed by a processor cause the processor to perform a method of any one of aspects 1 through 4.

Aspect 8: A method of wireless communication for an apparatus, comprising: receiving, from a user equipment (UE), identification information associated with the UE, wherein the identification information includes at least, an identifier of the UE, an identifier of an application server in an edge data network, and a token associated with the application server, wherein the identifier of the UE is independent of an Internet Protocol (IP) address of the UE; receiving, from the application server, a service request including at least the token and the identifier of the application server, wherein the apparatus includes a mapping between an edge enabler client identifier (EEC ID), the token, the identifier of the application server, and the identifier of the UE; and transmitting, to the application server, a message in response to the service request.

Aspect 9: The method of aspect 8, further comprising: determining at least one of the EEC ID or the identifier of the UE in response to the service request based on the token, the identifier of the application server, and the mapping between the EEC ID, the token, the identifier of the application server, and the identifier of the UE; and executing the service request based on at least one of the EEC ID or the identifier of the UE.

Aspect 10: The method of aspect 8 or 9, further comprising: generating a table including the mapping between the token, the identifier of the application server, and the identifier of the UE.

Aspect 11: The method of any of aspects 8 through 10, wherein the identifier of the UE is a generic public subscription identifier (GPSI) or the token.

Aspect 12: The method of any of aspects 8 through 11, further comprising: assigning a second identifier to the UE; and transmitting the second identifier of the UE to the application server, wherein the mapping between the edge enabler client identifier (EEC ID), the token, the identifier of the application server, and the identifier of the UE maps the second UE identifier to the edge enabler client identifier (EEC ID), the token, the identifier of the application server, and the identifier of the UE.

Aspect 13: An apparatus for wireless communication, comprising: a memory; and at least one processor coupled to the memory and configured to perform a method of any one of aspects 8 through 12.

Aspect 14: An apparatus for wireless communication comprising at least one means for performing a method of any one of aspects 8 through 12.

Aspect 15: A computer-readable medium storing computer executable code, the code when executed by a processor cause the processor to perform a method of any one of aspects 8 through 12.

Aspect 16: A method of wireless communication, comprising: receiving a network address of a first server configured to provide public network address information associated with a user equipment (UE); transmitting, to the first server based on the network address, a request for the public network address information associated with the UE; receiving the public network address information associated with the UE from the first server in response to the request; and transmitting, to a second server in an edge data network, the public network address information associated with the UE and private network address information associated with the UE when network address translation is applied to the private network address information associated with the UE.

Aspect 17: The method of aspect 16, wherein the receiving the network address of the first server configured to provide public network address information associated with the UE comprises: receiving the network address of the first server from at least one of: an entity in a core network via a parameter in a protocol configuration options (PCO) information element (IE), an edge configuration server (ECS) in an edge data network, or an edge enabler server (EES) in the edge data network.

Aspect 18: The method of aspect 16 or 17, wherein the first server is a Session Traversal Utilities for NAT (STUN) server and the second server is an edge enabler server (EES).

Aspect 19: The method of any of aspects 16 through 18, further comprising: transmitting an identifier of the UE to the second server.

Aspect 20: The method of any of aspects 16 through 19, wherein the identifier of the UE is a generic public subscription identifier (GPSI).

Aspect 21: The method of any of aspects 16 through 20, further comprising: determining whether network address translation is applied to the private network address information associated with the UE.

Aspect 22: An apparatus for wireless communication, comprising: a memory; and at least one processor coupled to the memory and configured to perform a method of any one of aspects 16 through 21.

Aspect 23: An apparatus for wireless communication comprising at least one means for performing a method of any one of aspects 16 through 21.

Aspect 24: A computer-readable medium storing computer executable code, the code when executed by a processor cause the processor to perform a method of any one of aspects 16 through 21.

Aspect 25: A method of wireless communication for an apparatus, comprising: receiving, from a user equipment (UE), at least public network address information associated with the UE; receiving, from an application server in an edge data network, a service request including at least the public network address information associated with the UE, wherein the apparatus includes a mapping between private network address information associated with the UE and the public network address information associated with the UE; and transmitting, to the application server in the edge data network, a message in response to the service request.

Aspect 26: The method of aspect 25, further comprising: determining the private network address information associated with the UE in response to the service request based on the public network address information associated with the UE and the mapping between the private network address information associated with the UE and the public network address information associated with the UE; and executing the service request based on the private network address information associated with the UE.

Aspect 27: The method of aspect 25 or 26, wherein executing the service request comprises: invoking a network exposure function (NEF) application programming interface (API) based on the private network address information associated with the UE.

Aspect 28: The method of any of aspects 25 through 27, further comprising: transmitting, to the UE, a network address of a server configured to provide the public network address information associated with the UE.

Aspect 29: The method of any of aspects 25 through 28, further comprising: receiving, from the UE, an identifier of the UE, wherein the mapping between the private network address information associated with the UE and the public network address information associated with the UE maps the identifier of the UE to the private network address information associated with the UE and the public network address information associated with the UE.

Aspect 30: The method of any of aspects 25 through 29, wherein the identifier of the UE is a generic public subscription identifier (GPSI).

Aspect 31: The method of any of aspects 25 through 30, wherein the public network address information associated with the UE includes a first Internet Protocol (IP) address and a first port number, and wherein the private network address information associated with the UE includes a second IP address and a second port number.

Aspect 32: The method of any of aspects 25 through 31, further comprising: assigning an identifier to the UE; and transmitting the identifier of the UE to the application server, wherein the mapping between the private network address information associated with the UE and the public network address information associated with the UE maps the identifier of the UE to the private network address information associated with the UE and the public network address information associated with the UE.

Aspect 33: An apparatus for wireless communication, comprising: a memory; and at least one processor coupled to the memory and configured to perform a method of any one of aspects 25 through 32.

Aspect 34: An apparatus for wireless communication comprising at least one means for performing a method of any one of aspects 25 through 32.

Aspect 35: A computer-readable medium storing computer executable code, the code when executed by a processor cause the processor to perform a method of any one of aspects 25 through 32.

Aspect 36: A method of wireless communication for an apparatus, comprising: receiving, from a user equipment (UE), a message including at least one user plane data packet; determining public network address information of the UE based on the message; receiving, from a network address translation (NAT) device, private network address information associated with the UE; receiving, from an application server in an edge data network, a service request including at least the public network address information associated with the UE, wherein the apparatus includes a mapping between the private network address information associated with the UE and the public network address information associated with the UE; and transmitting, to the application server in the edge data network, a message in response to the service request.

Aspect 37: The method of aspect 36, further comprising: determining an identifier of the UE from the public network address information associated with the UE, wherein the mapping between the private network address information associated with the UE and the public network address information associated with the UE maps the identifier of the UE to the private network address information associated with the UE and the public network address information associated with the UE.

Aspect 38: The method of aspect 36 or 37, wherein the identifier of the UE is a generic public subscription identifier (GPSI).

Aspect 39: The method of any of aspects 36 through 38, further comprising: assigning an identifier to the UE; and transmitting the identifier to the application server; wherein the mapping between the private network address information associated with the UE and the public network address information associated with the UE maps the identifier to the private network address information associated with the UE and the public network address information associated with the UE.

Aspect 40: An apparatus for wireless communication, comprising: a memory; and at least one processor coupled to the memory and configured to perform a method of any one of aspects 36 through 39.

Aspect 41: An apparatus for wireless communication comprising at least one means for performing a method of any one of aspects 36 through 39.

Aspect 42: A computer-readable medium storing computer executable code, the code when executed by a processor cause the processor to perform a method of any one of aspects 36 through 39.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module.” “mechanism.” “clement.” “device.” and the like may not be a substitute for the word “means.” As such, no claim clement is to be construed as a means plus function unless the clement is expressly recited using the phrase “means for.”

What is claimed is:

1. An apparatus for wireless communication, comprising:
a memory; and
at least one processor coupled to the memory and configured to:
receive a token from a first server in an edge data network; and
transmit identification information associated with the apparatus to a second server of the edge data network, wherein the identification information includes at least the token, an identifier of the apparatus, and an identifier of the first server, wherein the identifier of the apparatus is independent of an Internet Protocol (IP) address of the apparatus.

2. The apparatus of claim 1, wherein the identifier of the apparatus is a generic public subscription identifier (GPSI).

3. The apparatus of claim 1, wherein the first server is an edge application server (EAS) and the second server is an edge enabler server (EES).

4. The apparatus of claim 1, wherein the identification information is associated with an identifier of an edge enabler client (EEC) in the apparatus.

5. An apparatus for wireless communication, comprising:
a memory; and
at least one processor coupled to the memory and configured to:
receive, from a user equipment (UE), identification information associated with the UE, wherein the identification information includes at least, an identifier of the UE, an identifier of an application server in an edge data network, and a token associated with the application server, wherein the identifier of the UE is independent of an Internet Protocol (IP) address of the UE;
receive, from the application server, a service request including at least the token and the identifier of the application server, wherein the apparatus includes a mapping between an edge enabler client identifier (EEC ID), the token, the identifier of the application server, and the identifier of the UE; and
transmit, to the application server, a message in response to the service request based at least on the mapping.

6. The apparatus of claim 5, wherein the at least one processor is further configured to:
determine at least one of the EEC ID or the identifier of the UE in response to the service request based on the token, the identifier of the application server, and the mapping between the EEC ID, the token, the identifier of the application server, and the identifier of the UE; and
execute the service request based on at least one of the EEC ID or the identifier of the UE.

7. The apparatus of claim 5, wherein the at least one processor is further configured to:
generate a table including the mapping between the token, the identifier of the application server, and the identifier of the UE.

8. The apparatus of claim 5, wherein the identifier of the UE is a generic public subscription identifier (GPSI) or the token.

9. The apparatus of claim 5, wherein the at least one processor is further configured to:
assign a second identifier to the UE;
transmit the second identifier of the UE to the application server; and
wherein the mapping between the edge enabler client identifier (EEC ID), the token, the identifier of the application server, and the identifier of the UE maps the second identifier of the UE to the edge enabler client identifier (EEC ID), the token, the identifier of the application server, and the identifier of the UE.

10. An apparatus for wireless communication, comprising:
a memory; and
at least one processor coupled to the memory and configured to:
receive a network address of a first server configured to provide public network address information associated with the apparatus;
transmit, to the first server based on the network address, a request for the public network address information associated with the apparatus;
receive the public network address information associated with the apparatus from the first server in response to the request; and
transmit, to a second server in an edge data network, the public network address information associated with the apparatus and private network address information associated with the apparatus when network address translation is applied to the private network address information associated with the apparatus.

11. The apparatus of claim 10, wherein the at least one processor configured to receive the network address of the first server is further configured to:
receive the network address of the first server from at least one of:
an entity in a core network via a parameter in a protocol configuration options (PCO) information element (IE),
an edge configuration server (ECS) in an edge data network, or
an edge enabler server (EES) in the edge data network.

12. The apparatus of claim 10, wherein the first server is a Session Traversal Utilities for NAT (STUN) server and the second server is an edge enabler server (EES).

13. The apparatus of claim 10, wherein the at least one processor is further configured to:
transmit an identifier of the apparatus to the second server.

14. The apparatus of claim 13, wherein the identifier of the apparatus is a generic public subscription identifier (GPSI).

15. The apparatus of claim 10, wherein the at least one processor is further configured to:
determine whether network address translation is applied to the private network address information associated with the apparatus.

16. An apparatus for wireless communication, comprising:
a memory; and
at least one processor coupled to the memory and configured to:
receive, from a user equipment (UE), at least public network address information associated with the UE;
receive, from an application server in an edge data network, a service request including at least the public network address information associated with the UE, wherein the apparatus includes a mapping between private network address information associated with the UE and the public network address information associated with the UE; and
transmit, to the application server in the edge data network, a message in response to the service request based on at least the mapping.

17. The apparatus of claim 16, wherein the at least one processor is further configured to:
determine the private network address information associated with the UE in response to the service request based on the public network address information associated with the UE and the mapping between the private network address information associated with the UE and the public network address information associated with the UE; and
execute the service request based on the private network address information associated with the UE.

18. The apparatus of claim 17, wherein the least one processor configured to execute the service request is further configured to:
invoke a network exposure function (NEF) application programming interface (API) based on the private network address information associated with the UE.

19. The apparatus of claim 16, wherein the at least one processor is further configured to:
transmit, to the UE, a network address of a server configured to provide the public network address information associated with the UE.

20. The apparatus of claim 16, wherein the at least one processor is further configured to:
receive, from the UE, an identifier of the UE, wherein the mapping between the private network address information associated with the UE and the public network address information associated with the UE maps the identifier of the UE to the private network address information associated with the UE and the public network address information associated with the UE.

21. The apparatus of claim 20, wherein the identifier of the UE is a generic public subscription identifier (GPSI).

22. The apparatus of claim 16, wherein the public network address information associated with the UE includes a first Internet Protocol (IP) address and a first port number, and wherein the private network address information associated with the UE includes a second IP address and a second port number.

23. The apparatus of claim 16, wherein the at least one processor is further configured to:
assign an identifier to the UE; and
transmit the identifier of the UE to the application server, wherein the mapping between the private network address information associated with the UE and the public network address information associated with the UE maps the identifier of the UE to the private network address information associated with the UE and the public network address information associated with the UE.

24. An apparatus for wireless communication, comprising:
a memory; and
at least one processor coupled to the memory and configured to:
receive, from a user equipment (UE), a message including at least one user plane data packet;
determine public network address information of the UE based on the message;
receive, from a network address translation (NAT) device, private network address information associated with the UE;
receive, from an application server in an edge data network, a service request including at least the public network address information associated with the UE, wherein the apparatus includes a mapping between the private network address information associated with the UE and the public network address information associated with the UE; and
transmit, to the application server in the edge data network, a message in response to the service request based on at least the mapping.

25. The apparatus of claim 24, wherein the at least one processor is further configured to:
determine an identifier of the UE from the public network address information associated with the UE, wherein the mapping between the private network address information associated with the UE and the public network address information associated with the UE maps the identifier of the UE to the private network address information associated with the UE and the public network address information associated with the UE.

26. The apparatus of claim 25, wherein the identifier of the UE is a generic public subscription identifier (GPSI).

27. The apparatus of claim 24, wherein the at least one processor is further configured to:
assign an identifier to the UE; and
transmit the identifier to the application server;
wherein the mapping between the private network address information associated with the UE and the public network address information associated with the UE maps the identifier to the private network address information associated with the UE and the public network address information associated with the UE.

28. The apparatus of claim 24, wherein the at least one processor is further configured to:
execute the service request based on the private network address information associated with the UE, and wherein the transmitted message includes information associated with the executed service request.
